(19) United States
(12) Patent Application Publication
(10) Pub. No.: US 2017/0272833 A1
(43) Pub. Date: Sep. 21, 2017

(54) LAST PLAYED BAR WITH VIDEO-ON-DEMAND (VOD) AND DIGITAL VIDEO RECORDER (DVR) OPTIONS

(71) Applicant: Charter Communications Operating, LLC, St. Louis, MO (US)

(72) Inventor: DAN VAN HANDEL, BROOMFIELD, CO (US)

(21) Appl. No.: 15/396,599

(22) Filed: Dec. 31, 2016

Related U.S. Application Data
(60) Provisional application No. 62/310,693, filed on Mar. 19, 2016.

(51) Int. Cl. H04N 21/6587; H04N 21/482; H04N 21/438; H04N 21/4147; H04N 21/472

(52) U.S. Cl. CPC H04N 21/6587; H04N 21/4147; H04N 21/47202; H04N 21/4383; H04N 21/4821; H04N 21/47217

(57) ABSTRACT

A recently-viewed stack of session objects is formed, corresponding to assets recently played on consumer premises equipment in a video content network. The session objects include linear session objects corresponding to linear ones of the assets and non-linear session objects corresponding to non-linear ones of the assets. A user selection to resume playing one of the non-linear assets is obtained (e.g., from a channel surfer application). Responsive to the user selection, a switch is made from a currently viewed program to the aforementioned one of the non-linear assets.

### CROSS-REFERENCE TO RELATED APPLICATION(S)

This application claims the benefit of U.S. Provisional Application Ser. No. 62/310,693, filed on 19 Mar. 2016, the complete disclosure of which is expressly incorporated herein by reference in its entirety for all purposes.

### FIELD OF THE INVENTION

The present invention relates generally to video content networks, and, more particularly, to user interfaces for such networks, or the like.

### BACKGROUND OF THE INVENTION

A variety of techniques have been used to permit viewers accessing a video content network to select content to be viewed. For example, in a broadcast media environment, electronic program guides (EPGs) provide users of television, radio, and other media applications with continuously updated on-screen menus displaying broadcast programming or scheduling information relating to current and upcoming programming. An EPG is essentially the modern equivalent of the television listings traditionally printed in a local newspaper or TV magazine.

Interactive program guides (IPGs), a sub-class of EPGs, can be made available through television (e.g., on set-top boxes), mobile phones, and on the Internet. Digital television technology allows local broadcasters to transmit program-guide information to a digital television (or set-top box) along with regular programming content. Digital television brings electronic program guides, already familiar to many cable viewers, to households that rely on over-the-air broadcasts.

One feature of an EPG is its graphical user interface (GUI), typically including a grid or table listing channel names and program titles and times; web and television-based IPG interfaces allow the user to select any given program listing for an available channel and display additional information about the program supplied by the IPG provider. Typical IPGs also allow users the ability to navigate through the IPG listings using selected search criteria such as genre, time, title, etc., as well as providing immediate one-touch access to, or recording of, a selected program.

One prior art user interface to a video content network is a so-called “channel surfer.” In some current channel surfer applications, on the bottom of the screen there is a line of box art for linear channels. When the user brings up the application, he or she can scroll back and forth across live channels. When he or she selects one, the application causes the CPE to tune to that channel. It is also possible to “arrow up” into a “recent channels” menu; the user can scroll through that menu and quickly tune back to whatever linear content he or she was just looking at (a “last played” bar).

### SUMMARY OF THE INVENTION

Principles of the present invention provide a last played bar with video-on-demand (VOD) and digital video recorder (DVR) options. In one aspect, an exemplary method includes forming a recently-viewed stack of session objects corresponding to assets recently played on consumer premises equipment in a video content network. The session objects include linear session objects corresponding to linear ones of the assets and non-linear session objects corresponding to non-linear ones of the assets. Further steps include obtaining a user selection to resume playing one of the non-linear ones of the assets; and, responsive to the user selection, switching from a currently viewed program to the one of the non-linear ones of the assets.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a machine readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus (e.g., set-top terminal) including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein. The means do not include a transmission medium per se or a disembodied signal per se.

Techniques of the present invention can provide substantial beneficial technical effects, as will be appreciated by the skilled artisan from the descriptions herein. The user is provided with a simplified and expedited way to resume an asset, which, in one or more embodiments, is consistent for all assets and allows for extensibility to other asset types (e.g. “YouTube” videos).

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram of an exemplary embodiment of a system, within which one or more aspects of the invention can be implemented;

FIG. 2 is a functional block diagram illustrating an exemplary hybrid fiber-coaxial (HFC) divisional network configuration, useful within the system of FIG. 1;

FIG. 3 is a functional block diagram illustrating one exemplary HFC cable network head-end configuration, useful within the system of FIG. 1;

FIG. 4 is a functional block diagram illustrating one exemplary local service node configuration useful within the system of FIG. 1;

FIG. 5 is a functional block diagram of a premises network, including an exemplary centralized customer premises equipment (CPE) unit, interfacing with a head end such as that of FIG. 3;

FIG. 6 is a functional block diagram of an exemplary centralized CPE unit, useful within the system of FIG. 1;

FIG. 7 is a block diagram of a computer system useful in connection with one or more aspects of the invention;

FIG. 8 is a simulated screen shot showing a most recently watched linear item with linear and nonlinear items also present in a recently watched list, according to an aspect of the invention;

FIG. 9 is a simulated screen shot showing a most recently watched on demand item with linear and nonlinear items also present in a recently watched list, according to an aspect of the invention;

FIG. 10 is a simulated screen shot showing a most recently watched DVR item with linear and nonlinear items also present in a recently watched list, according to an aspect of the invention;

FIG. 11 shows class instance variables for RecentlyViewedItemBase Class, according to an aspect of the invention;

FIGS. 12A-12D show methods for RecentlyViewedItemBase Class, according to an aspect of the invention;

FIGS. 13A-13B show methods for RecentlyViewedDvrItem Class, according to an aspect of the invention;

FIGS. 14A-14C show methods for Recently ViewedVodItem Class, according to an aspect of the invention;

FIG. 15 shows additional class instance variables for Recently ViewedLinearItem Class, according to an aspect of the invention; and

FIGS. 16A-16C show methods for Recently ViewedLinearItem Class, according to an aspect of the invention.

### DETAILED DESCRIPTION OF PREFERRED EMBODIMENTS

Purely by way of example and not limitation, one or more embodiments will be illustrated in the context of a cable multi-service operator (MSO) providing data services as well as entertainment services. However, one or more embodiments could be used in the context of other video content networks, which might or might not also provide data services.

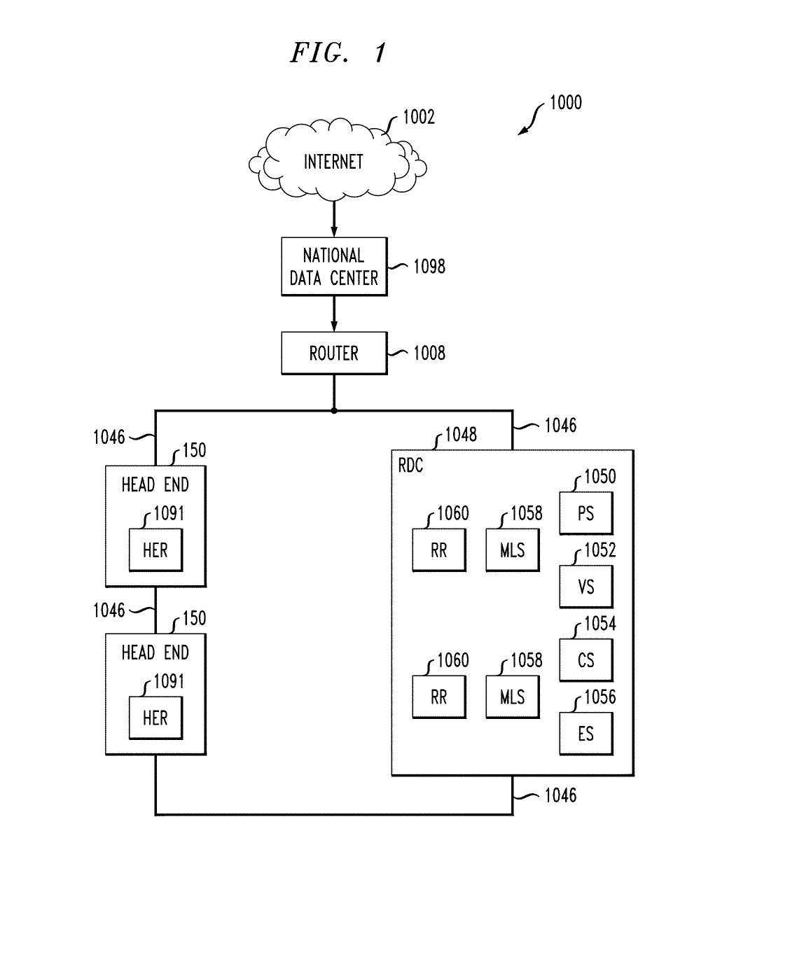

FIG. 1 shows an exemplary system 1000, according to an aspect of the invention. System 1000 includes a regional data center (RDC) 1048, and one or more divisions, represented by division head ends 150. RDC 1048 and head ends 150 are interconnected by a network 1046; by way of example and not limitation, a dense wavelength division multiplex (DWDM) network. Elements 1048, 150 on network 1046 may be operated, for example, by or on behalf of a cable MSO, and may be interconnected with a global system of interconnected computer networks that use the standardized Internet Protocol Suite (TCP/IP)(transfer control protocol/Internet protocol), commonly called the Internet 1002; for example, via router 1008. In one or more non-limiting exemplary embodiments, router 1008 is a point-of-presence (“POP”) router; for example, of the kind available from Juniper Networks, Inc., Sunnyvale, Calif., USA.

Head ends 150 may each include a head end router (HER) 1091 which interfaces with network 1046. Head end routers 1091 are omitted from figures below to avoid clutter.

RDC 1048 may include one or more provisioning servers (PS) 1050, one or more Video Servers (VS) 1052, one or more content servers (CS) 1054, and one or more e-mail servers (ES) 1056. The same may be interconnected to one or more RDC routers (RR) 1060 by one or more multi-layer switches (MLS) 1058. RDC routers 1060 interconnect with network 1046.

A national data center (NDC) 1098 is provided in some instances; for example, between router 1008 and Internet 1002. In one or more embodiments, such an NDC may consolidate at least some functionality from head ends and/or regional data centers. For example, such an NDC might include one or more VOD servers; switched digital video (SDV) functionality; gateways to obtain content (e.g., program content) from various sources including cable feeds and/or satellite; and so on. One or more embodiments may have multiple RDCs 1048. Some embodiments could have more than one NDC 1098.

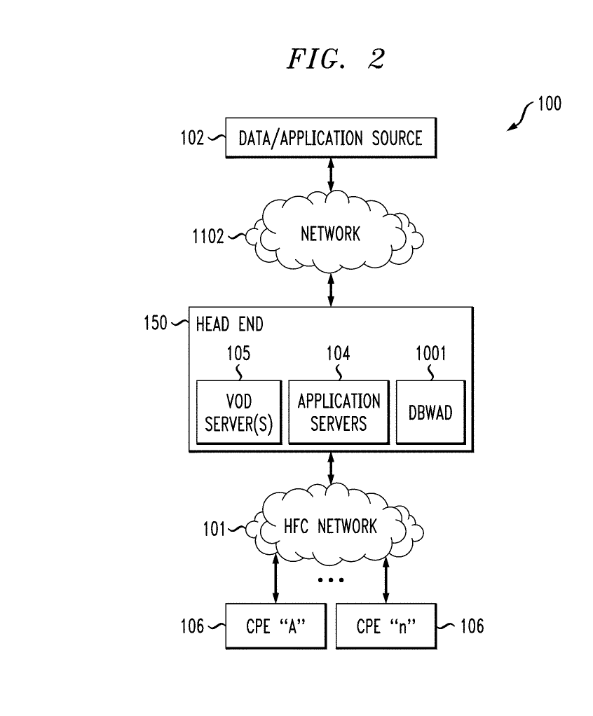

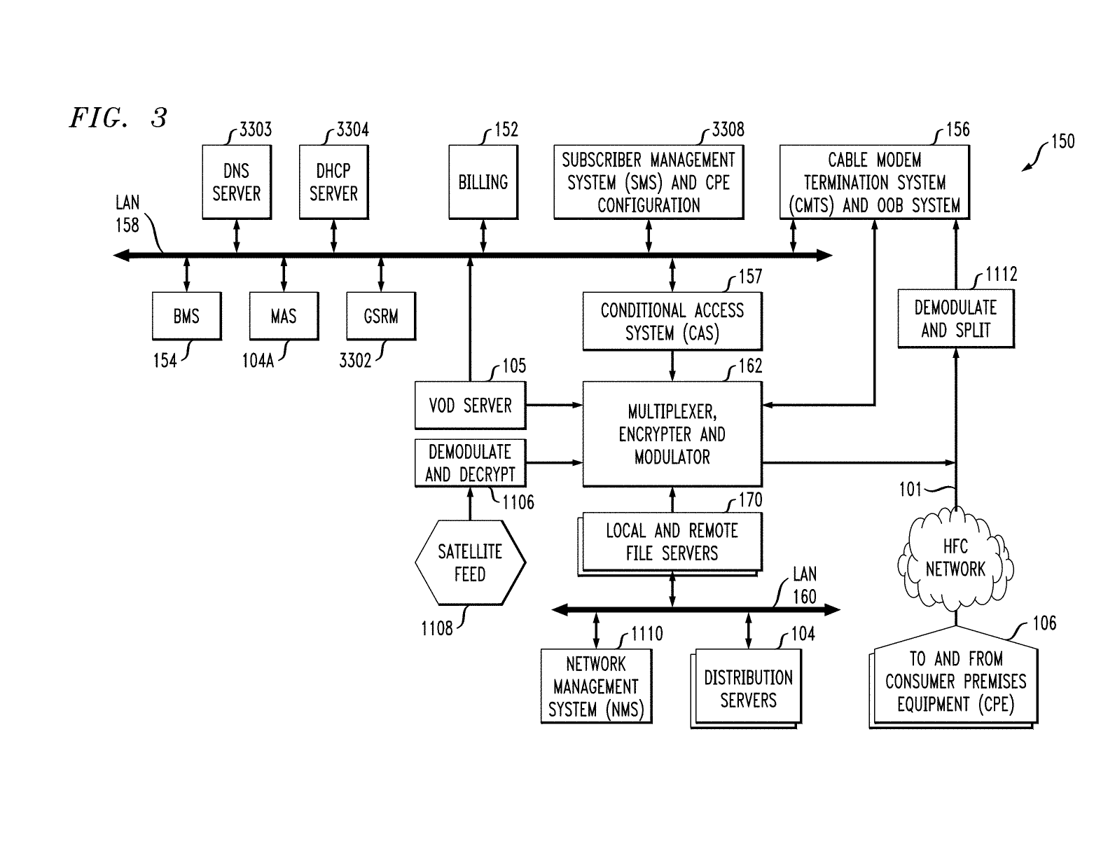

FIG. 2 is a functional block diagram illustrating an exemplary content-based (e.g., hybrid fiber-coaxial (HFC)) divisional network configuration, useful within the system of FIG. 1. See, for example, US Patent Publication 2006/0130107 of Gonder et al., entitled “Method and apparatus for high bandwidth data transmission in content-based networks,” the complete disclosure of which is expressly incorporated by reference herein in its entirety for all purposes. The various components of the network 100 include (i) one or more data and application origination points 102; (ii) one or more application distribution servers 104; (iii) one or more video-on-demand (VOD) servers 105, and (v) consumer premises equipment or customer premises equipment (CPE) 106. The distribution server(s) 104, VOD servers 105 and CPE(s) 106 are connected via a bearer (e.g., HFC) network 101. Servers 104, 105 can be located in head end 150. A simple architecture is shown in FIG. 2 for illustrative brevity, although it will be recognized that comparable architectures with multiple origination points, distribution servers, VOD servers, and/or CPE devices (as well as different network topologies) may be utilized consistent with embodiments of the invention. For example, the head-end architecture of FIG. 3 (described in greater detail below) may be used.

The data/application origination point 102 comprises any medium that allows data and/or applications (such as a VOD-based or “Watch TV” application) to be transferred to a distribution server 104, for example, over network 1102. This can include for example a third party data source, application vendor website, compact disk read-only memory (CD-ROM), external network interface, mass storage device (e.g., Redundant Arrays of Inexpensive Disks (RAID) system), etc. Such transference may be automatic, initiated upon the occurrence of one or more specified events (such as the receipt of a request packet or acknowledgement (ACK)), performed manually, or accomplished in any number of other modes readily recognized by those of ordinary skill, given the teachings herein. For example, in one or more embodiments, network 1102 may correspond to network 1046 of FIG. 1, and the data and application origination point may be, for example, within NDC 1098, RDC 1048, or on the Internet 1002. Head end 150, HFC network 101, and CPEs 106 thus represent the divisions which were represented by division head ends 150 in FIG. 1.

The application distribution server 104 comprises a computer system where such applications can enter the network system. Distribution servers per se are well known in the networking arts, and accordingly not described further herein.

The VOD server 105 comprises a computer system where on-demand content can be received from one or more of the aforementioned data sources 102 and enter the network system. These servers may generate the content locally, or alternatively act as a gateway or intermediary from a distant source.

The CPE 106 includes any equipment in the “customers' premises” (or other appropriate locations) that can be accessed by a distribution server 104 or a cable modem termination system 156 (discussed below with regard to FIG. 3). Non-limiting examples of CPE are set-top boxes and high-speed cable modems for providing high bandwidth Internet access in premises such as homes and businesses.

Also included (for example, in head end 150) is a dynamic bandwidth allocation device (DBWAD) 1001 such as a global session resource manager, which is itself a non-limiting example of a session resource manager.

FIG. 3 is a functional block diagram illustrating one exemplary HFC cable network head-end configuration, useful within the system of FIG. 1. As shown in FIG. 3, the head-end architecture 150 comprises typical head-end components and services including billing module 152, subscriber management system (SMS) and CPE configuration management module 3308, cable-modem termination system (CMTS) and out-of-band (OOB) system 156, as well as LAN(s) 158, 160 placing the various components in data communication with one another. In one or more embodiments, there are multiple CMTSs. Each may be coupled to an HER 1091, for example. See, e.g., FIGS. 1 and 2 of co-assigned U.S. Pat. No. 7,792,963 of inventors Gould and Danforth, entitled METHOD TO BLOCK UNAUTHORIZED NETWORK TRAFFIC IN A CABLE DATA NETWORK, the complete disclosure of which is expressly incorporated herein by reference in its entirety for all purposes.

It will be appreciated that while a bar or bus LAN topology is illustrated, any number of other arrangements (e.g., ring, star, etc.) may be used consistent with the invention. It will also be appreciated that the head-end configuration depicted in FIG. 3 is high-level, conceptual architecture and that each multi-service operator (MSO) may have multiple head-ends deployed using custom architectures.

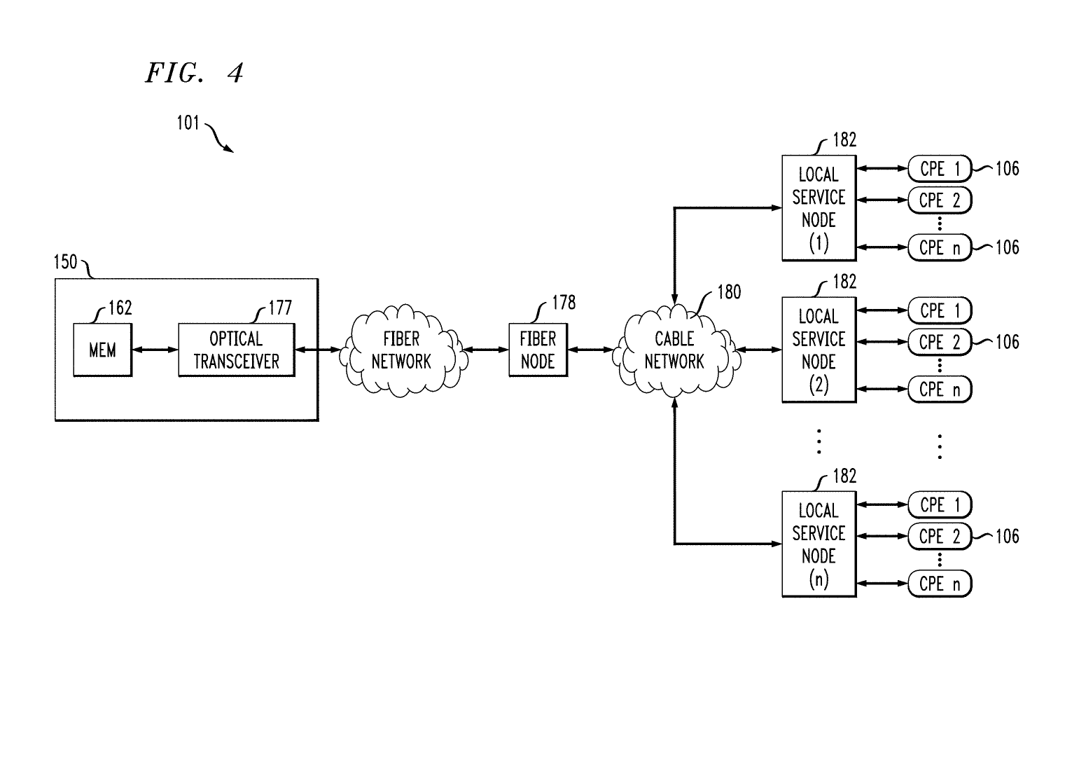

The architecture 150 of FIG. 3 further includes a multiplexer/encrypter/modulator (MEM) 162 coupled to the HFC network 101 adapted to “condition” content for transmission over the network. The distribution servers 104 are coupled to the LAN 160, which provides access to the MEM 162 and network 101 via one or more file servers 170. The VOD servers 105 are coupled to the LAN 158, although other architectures may be employed (such as for example where the VOD servers are associated with a core switching device such as an 802.3z Gigabit Ethernet device; or the VOD servers could be coupled to LAN 160). Since information is typically carried across multiple channels, the head-end should be adapted to acquire the information for the carried channels from various sources. Typically, the channels being delivered from the head-end 150 to the CPE 106 (“downstream”) are multiplexed together in the head-end and sent to neighborhood hubs (refer to description of FIG. 4) via a variety of interposed network components.

Content (e.g., traditional audio, traditional (as distinguished from Internet Protocol Television (IPTV)) video, etc.) is provided in each downstream (in-band) channel associated with the relevant service group. (Note that in the context of data communications, internet data is passed both downstream and upstream.) To communicate with the head-end or intermediary node (e.g., hub server), the CPE 106 may use the out-of-band (OOB) or DOCSIS® (Data Over Cable Service Interface Specification) channels (registered mark of Cable Television Laboratories, Inc., 400 Centennial Parkway Louisville Colo. 80027, USA) and associated protocols (e.g., DOCSIS 1.x, 2.0. or 3.0). The OpenCable™ Application Platform (OCAP) 1.0, 2.0, 3.0 (and subsequent) specification (Cable Television laboratories Inc.) provides for exemplary networking protocols both downstream and upstream, although the invention is in no way limited to these approaches. All versions of the DOCSIS and OCAP specifications are expressly incorporated herein by reference in their entireties for all purposes.

Furthermore in this regard, DOCSIS is an international telecommunications standard that permits the addition of high-speed data transfer to an existing cable TV (CATV) system. It is employed by many cable television operators to provide Internet access (cable Internet) over their existing hybrid fiber-coaxial (HFC) infrastructure. It will also be recognized that multiple servers (broadcast, VOD, or otherwise) can be used, and disposed at two or more different locations if desired, such as being part of different server “farms”. These multiple servers can be used to feed one service group, or alternatively different service groups. In a simple architecture, a single server is used to feed one or more service groups. In another variant, multiple servers located at the same location are used to feed one or more service groups. In yet another variant, multiple servers disposed at different location are used to feed one or more service groups.

In some instances, material may also be obtained from a satellite feed 1108; such material is demodulated and decrypted in block 1106 and fed to block 162. Conditional access system 157 may be provided for access control purposes. Network management system 1110 may provide appropriate management functions. Note also that signals from MEM 162 and upstream signals from network 101 that have been demodulated and split in block 1112 are fed to CMTS and OOB system 156.

Also included in FIG. 3 are a global session resource manager (GSRM) 3302, a Mystro Application Server 104A, and a business management system 154, all of which are coupled to LAN 158. GSRM 3302 is one specific form of a DBWAD 1001 and is a non-limiting example of a session resource manager.

An ISP DNS server could be located in the head-end as shown at 3303, but it can also be located in a variety of other places. One or more DHCP server(s) 3304 can also be located where shown or in different locations.

As shown in FIG. 4, the network 101 of FIGS. 2 and 3 comprises a fiber/coax arrangement wherein the output of the MEM 162 of FIG. 3 is transferred to the optical domain (such as via an optical transceiver 177 at the head-end 150 or further downstream). The optical domain signals are then distributed over a fiber network to a fiber node 178, which further distributes the signals over a distribution network 180 (typically coax) to a plurality of local servicing nodes 182. This provides an effective 1-to-N expansion of the network at the local service end. Each node 182 services a number of CPEs 106. Further reference may be had to US Patent Publication 2007/0217436 of Markley et al., entitled “Methods and apparatus for centralized content and data delivery,” the complete disclosure of which is expressly incorporated herein by reference in its entirety for all purposes. In one or more embodiments, the CPE 106 includes a cable modem, such as a DOCSIS-compliant cable modem (DCCM). Please note that the number of CPE 106 per node 182 may be different than the number of nodes 182.

US Patent Publication 2010-0313236 of Albert Straub, entitled “TECHNIQUES FOR UPGRADING SOFTWARE IN A VIDEO CONTENT NETWORK,” the complete disclosure of which is expressly incorporated herein by reference for all purposes, provides additional details on the aforementioned dynamic bandwidth allocation device 1001.

US Patent Publication 2009-0248794 of William L. Helms, entitled “SYSTEM AND METHOD FOR CONTENT SHARING,” the complete disclosure of which is expressly incorporated herein by reference for all purposes, provides additional details on CPE in the form of a converged premises gateway device. Related aspects are also disclosed in US Patent Publication 2007-0217436 of Markley et al, entitled “METHODS AND APPARATUS FOR CENTRALIZED CONTENT AND DATA DELIVERY,” the complete disclosure of which is expressly incorporated herein by reference for all purposes.

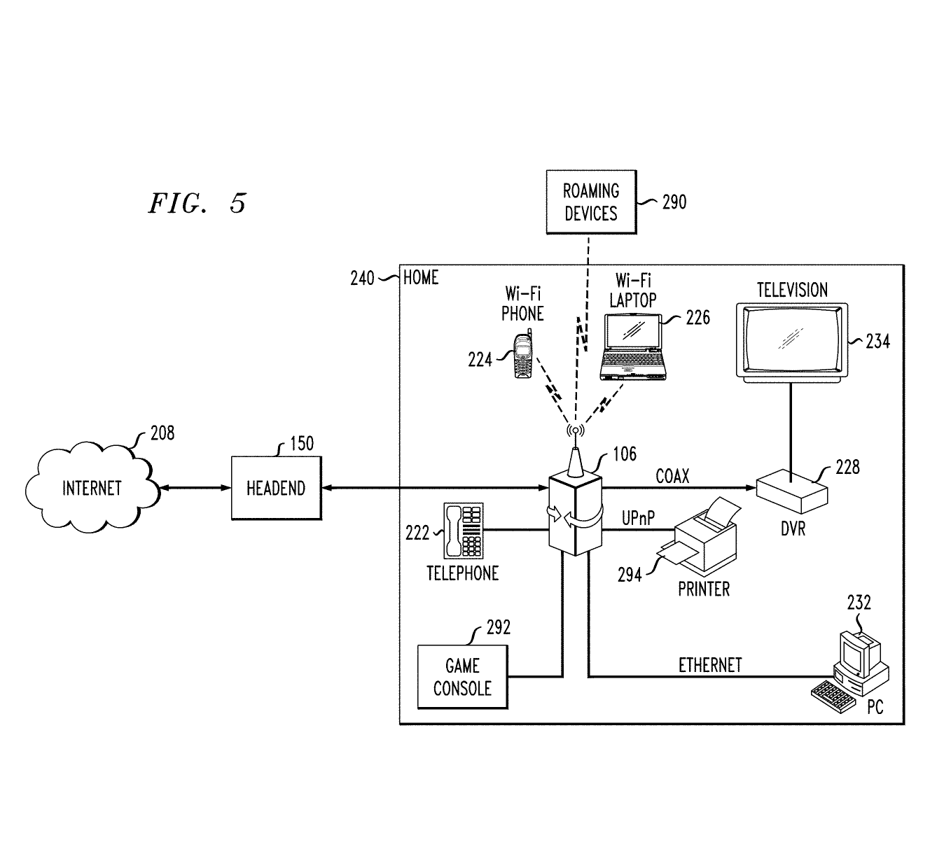

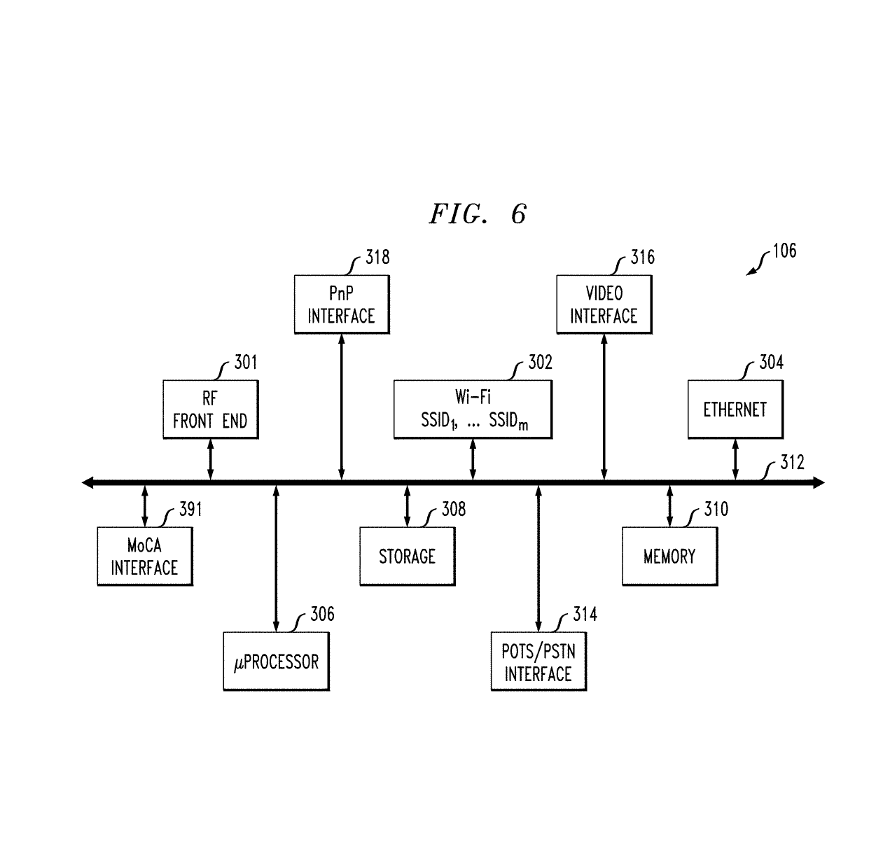

Reference should now be had to FIG. 5, which presents a block diagram of a premises network interfacing with a head end of an MSO or the like, providing Internet access. An exemplary advanced wireless gateway comprising CPE 106 is depicted as well. It is to be emphasized that the specific form of CPE 106 shown in FIGS. 5 and 6 is exemplary and non-limiting, and shows a number of optional features. Many other types of CPE can be employed in one or more embodiments; for example, a cable modem, DSL modem, and the like.

CPE 106 includes an advanced wireless gateway which connects to a head end 150 or other hub of a network, such as a video content network of an MSO or the like. The head end is coupled also to an internet (e.g., the Internet) 208 which is located external to the head end 150, such as via an Internet (IP) backbone or gateway (not shown).

The head end is in the illustrated embodiment coupled to multiple households or other premises, including the exemplary illustrated household 240. In particular, the head end (for example, a cable modem termination system 156 thereof) is coupled via the aforementioned HFC network and local coaxial cable or fiber drop to the premises, including the consumer premises equipment (CPE) 106. The exemplary CPE 106 is in signal communication with any number of different devices including, e.g., a wired telephony unit 222, a Wi-Fi or other wireless-enabled phone 224, a Wi-Fi or other wireless-enabled laptop 226, a session initiation protocol (SIP) phone, an H.323 terminal or gateway, etc. Additionally, the CPE 106 is also coupled to a digital video recorder (DVR) 228 (e.g., over coax), in turn coupled to television 234 via a wired or wireless interface (e.g., cabling, PAN or 802.15 UWB micro-net, etc.). CPE 106 is also in communication with a network (here, an Ethernet network compliant with IEEE Std. 802.3, although any number of other network protocols and topologies could be used) on which is a personal computer (PC) 232.

Other non-limiting exemplary devices that CPE 106 may communicate with include a printer 294; for example over a universal plug and play (UPnP) interface, and/or a game console 292; for example, over a multimedia over coax alliance (MoCA) interface. Game console 292 could be connected to CPE 106 by, for example, Ethernet, Wi-Fi, or MoCA (e.g. via a MoCA-to-Ethernet bridge).

In some instances, CPE 106 is also in signal communication with one or more roaming devices, generally represented by block 290.

A “home LAN” (HLAN) is created in the exemplary embodiment, which may include for example the network formed over the installed coaxial cabling in the premises, the Wi-Fi network, and so forth.

During operation, the CPE 106 exchanges signals with the head end over the interposed coax (and/or other, e.g., fiber) bearer medium. The signals include e.g., IPTV or other Internet traffic (IPv4 or IPv6), digital programming and other digital signaling or content such as digital (packet-based; e.g., VoIP) telephone service. The CPE 106 then exchanges this digital information after demodulation and any decryption (and any demultiplexing) to the particular system(s) to which it is directed or addressed. For example, in one embodiment, a MAC address or IP address can be used as the basis of directing traffic within the client-side environment 240.

Any number of different data flows may occur within the network depicted in FIG. 5. For example, the CPE 106 may exchange digital telephone signals from the head end which are further exchanged with the telephone unit 222, the Wi-Fi phone 224, or one or more roaming devices 290. The digital telephone signals may be IP-based such as Voice-over-IP (VoIP), or may utilize another protocol or transport mechanism. The well-known session initiation protocol (SIP) may be used, for example, in the context of a “SIP phone” for making multi-media calls. The network may also interface with a cellular or other wireless system, such as for example a 3G IMS (IP multimedia subsystem) system, in order to provide multimedia calls between a user or consumer in the household domain 240 (e.g., using a SIP phone or H.323 terminal) and a mobile 3G telephone or personal media device (PMD) user via that user's radio access network (RAN).

The CPE 106 may also exchange Internet traffic (e.g., TCP/IP and other packets) with the head end 150 which is further exchanged with the Wi-Fi laptop 226, the PC 232, one or more roaming devices 290, the gaming console 292, or other device (e.g., media streamer). CPE 106 may also receive digital programming that is forwarded to the DVR 228 or to the television 234. Programming requests and other control information may be received by the CPE 106 and forwarded to the head end as well for appropriate handling.

FIG. 6 is a block diagram of one exemplary embodiment of the CPE 106 of FIG. 5. The exemplary CPE 106 includes an RF front end 301, Wi-Fi interface 302, video interface 316, “Plug n′ Play” (PnP) interface 318 (for example, a UPnP interface) and Ethernet interface 304, each directly or indirectly coupled to a bus 312. In some cases, Wi-Fi interface 302 comprises a single wireless access point (WAP) running multiple (“m”) service set identifiers (SSIDs). In some cases, multiple SSIDs, which could represent different applications, are served from a common WAP. For example, SSID 1 is for the home user, while SSID 2 may be for a managed security service, SSID 3 may be a managed home networking service, SSID 4 may be a hot spot, and so on. Each of these is on a separate IP subnetwork for security, accounting, and policy reasons. The microprocessor 306, storage unit 308, plain old telephone service (POTS)/public switched telephone network (PSTN) interface 314, and memory unit 310 are also coupled to the exemplary bus 312, as is a suitable MoCA interface 391. The memory unit 310 typically comprises a random access memory (RAM) and storage unit 308 typically comprises a hard disk drive, an optical drive (e.g., CD-ROM or DVD), NAND flash memory, RAID (redundant array of inexpensive disks) configuration, or some combination thereof.

The illustrated CPE 106 can assume literally any discrete form factor, including those adapted for desktop, floor-standing, or wall-mounted use, or alternatively may be integrated in whole or part (e.g., on a common functional basis) with other devices if desired.

Again, it is to be emphasized that every embodiment need not necessarily have all the elements shown in FIG. 6—as noted, the specific form of CPE 106 shown in FIGS. 5 and 6 is exemplary and non-limiting, and shows a number of optional features. Yet again, many other types of CPE can be employed in one or more embodiments; for example, a cable modem, DSL modem, and the like.

It will be recognized that while a linear or centralized bus architecture is shown as the basis of the exemplary embodiment of FIG. 6, other bus architectures and topologies may be used. For example, a distributed or multi-stage bus architecture may be employed. Similarly, a “fabric” or other mechanism (e.g., crossbar switch, RAPIDIO interface, non-blocking matrix, TDMA or multiplexed system, etc.) may be used as the basis of at least some of the internal bus communications within the device. Furthermore, many if not all of the foregoing functions may be integrated into one or more integrated circuit (IC) devices in the form of an ASIC or “system-on-a-chip” (SoC). Myriad other architectures well known to those in the data processing and computer arts may accordingly be employed.

Yet again, it will also be recognized that the CPE configuration shown is essentially for illustrative purposes, and various other configurations of the CPE 106 are consistent with other embodiments of the invention. For example, the CPE 106 in FIG. 6 may not include all of the elements shown, and/or may include additional elements and interfaces such as for example an interface for the HomePlug A/V standard which transmits digital data over power lines, a PAN (e.g., 802.15), Bluetooth, or other short-range wireless interface for localized data communication, etc.

A suitable number of standard 10/100/1000 Base T Ethernet ports for the purpose of a Home LAN connection are provided in the exemplary device of FIG. 6; however, it will be appreciated that other rates (e.g., Gigabit Ethernet or 10-Gig-E) and local networking protocols (e.g., MoCA, USB, etc.) may be used. These interfaces may be serviced via a WLAN interface, wired RJ-45 ports, or otherwise. The CPE 106 can also include a plurality of RJ-11 ports for telephony interface, as well as a plurality of USB (e.g., USB 2.0) ports, and IEEE-1394 (Firewire) ports. S-video and other signal interfaces may also be provided if desired.

During operation of the CPE 106, software located in the storage unit 308 is run on the microprocessor 306 using the memory unit 310 (e.g., a program memory within or external to the microprocessor). The software controls the operation of the other components of the system, and provides various other functions within the CPE. Other system software/firmware may also be externally reprogrammed, such as using a download and reprogramming of the contents of the flash memory, replacement of files on the storage device or within other non-volatile storage, etc. This allows for remote reprogramming or reconfiguration of the CPE 106 by the MSO or other network agent.

The RF front end 301 of the exemplary embodiment comprises a cable modem of the type known in the art. In some cases, the CPE just includes the cable modem and omits the optional features. Content or data normally streamed over the cable modem can be received and distributed by the CPE 106, such as for example packetized video (e.g., IPTV). The digital data exchanged using RF front end 301 includes IP or other packetized protocol traffic that provides access to internet service. As is well known in cable modem technology, such data may be streamed over one or more dedicated QAMs resident on the HFC bearer medium, or even multiplexed or otherwise combined with QAMs allocated for content delivery, etc. The packetized (e.g., IP) traffic received by the CPE 106 may then be exchanged with other digital systems in the local environment 240 (or outside this environment by way of a gateway or portal) via, e.g. the Wi-Fi interface 302, Ethernet interface 304, MoCA interface 391, or plug-and-play (PnP) interface 318.

Additionally, the RF front end 301 modulates, encrypts/multiplexes as required, and transmits digital information for receipt by upstream entities such as the CMTS or a network server. This could include, for example, upstream commands from game console 292. In one or more embodiments, the game console does not communicate directly with the RF Front End 301; rather, it communicates with the RF Front End 301 over Ethernet 304 or Wi-Fi 302. Upstream commands from the game console 292 are sent to the RF Front End over Ethernet 304 or Wi-Fi 302 and then upstream into the network, from the RF Front End 301, via DOCSIS or the like. Digital data transmitted via the RF front end 301 may include, for example, MPEG-2 encoded programming data that is forwarded to a television monitor via the video interface 316. Programming data may also be stored on the CPE storage unit 308 for later distribution by way of the video interface 316, or using the Wi-Fi interface 302, Ethernet interface 304, Firewire (IEEE Std. 1394), USB/USB2, or any number of other such options.

Other devices such as portable music players (e.g., MP3 audio players) may be coupled to the CPE 106 via any number of different interfaces, and music and other media files downloaded for portable use and viewing.

In some instances, the CPE 106 includes a DOCSIS cable modem for delivery of traditional broadband Internet services. This connection can be shared by all Internet devices in the premises 240; e.g. Internet protocol television (IPTV) devices, PCs, laptops, etc., as well as by roaming devices 290. In addition, the CPE 106 can be remotely managed (such as from the head end 150, or another remote network agent) to support appropriate IP services.

In some instances the CPE 106 also creates a home Local Area Network (LAN) utilizing the existing coaxial cable in the home. For example, an Ethernet-over-coax based technology allows services to be delivered to other devices in the home utilizing a frequency outside (e.g., above) the traditional cable service delivery frequencies. For example, frequencies on the order of 1150 MHz could be used to deliver data and applications to other devices in the home such as PCs, PMDs, media extenders and set-top boxes. The coaxial network is merely the bearer; devices on the network utilize Ethernet or other comparable networking protocols over this bearer.

The exemplary CPE 106 shown in FIGS. 5 and 6 acts as a Wi-Fi access point (AP), thereby allowing Wi-Fi enabled devices to connect to the home network and access Internet, media, and other resources on the network. This functionality can be omitted in one or more embodiments, if not needed.

In one embodiment, Wi-Fi interface 302 comprises a single wireless access point (WAP) running multiple (“m”) service set identifiers (SSIDs). One or more SSIDs can be set aside for the home network while one or more SSIDs can be set aside for roaming devices 290.

A premises gateway software management package (application) is also provided to control, configure, monitor and provision the CPE 106 from the cable head-end 150 or other remote network node via the cable modem (DOCSIS) interface. This control allows a remote user to configure and monitor the CPE 106 and home network.

The MoCA interface 391 can be configured, for example, in accordance with the MoCA 1.0, 1.1, or 2.0 specifications.

As discussed above, the optional Wi-Fi wireless interface 302 is, in some instances, also configured to provide a plurality of unique service set identifiers (SSIDs) simultaneously. These SSIDs are configurable (locally or remotely), such as via a web page.

In addition to traditional “broadcast” content (e.g., video programming), the systems of FIGS. 1-6 also deliver Internet data services (including IPTV) using the Internet protocol (IP), although other protocols and transport mechanisms of the type well known in the digital communication art may be substituted. The IP packets are typically transmitted on RF channels that are different that the RF channels used for the broadcast traditional video and audio programming, although this is not a requirement. The CPE 106 are each configured to monitor the particular assigned RF channel (such as via a port or socket ID/address, or other such mechanism) for IP packets intended for the subscriber premises/address that they serve. Again, one or more embodiments can be used with different kinds of video content networks which may or may not also provide data services.

One or more embodiments enhance a user interface to a video content network; e.g., a so-called “channel surfer.” In some current channel surfer applications, on the bottom of the screen there is a line of box art for linear channels. When the user brings up the application, he or she can scroll back and forth across live channels. When he or she selects one, the application causes the CPE to tune to that channel. It is also possible to “arrow up” into a “recent channels” menu; the user can scroll through that menu and quickly tune back to whatever linear content he or she was just looking at (a “last played” bar).

One or more embodiments enhance such a prior art user interface with “session stacking” techniques such that the last played bar also includes non-linear content. For example, as will be discussed in greater detail below, the line of box art can be enhanced to include nonlinear material; the box art of a highlighted asset that is nonlinear shows a PLAY Icon when it is a Session object (e.g., On Demand (VOD) and/or DVR).

In one or more embodiments, when the user plays a VOD or DVR asset, the asset is added to the channel surfer's “Recently Viewed” filter at the point where the asset is bookmarked (thus, on a PAUSE or a STOP of the asset). Therefore, the user could be watching a Recorded Show or VOD asset, press PAUSE, tune to a sporting event to catch the live score, then bring up the channel surfer app and press PLAY to automatically resume the “Session” he or she was watching.

In at least some embodiments, duplicates are expunged, so that if the user “stacks” a VOD asset, for example, then plays it from the On Demand menu, the system will only stack the latest session instance. This is true for VOD, DVR and Live assets, in one or more embodiments.

Furthermore, in at least some instances, an expired VOD asset is purged from the list at the moment it is expired (either by rental window or asset license expiration), and/or a deleted DVR asset is purged from the list at the moment the user deletes it.

Advantageously, one or more embodiments provide a “Recently Viewed” channel surfer stack so that any type of asset can follow the general rules set forth above and be “stackable.” For example, essentially any asset that can be viewed (even, e.g., YOUTUBE videos (registered mark of Google Inc. Mountain View Calif. USA)) can also be stacked on the Recently Viewed list.

Thus, one or more embodiments enhance existing channel surfer applications. Non-limiting examples include the Time Warner Cable (TWC) OCAP Digital Navigator (ODN) platform and HNAV (hosted navigation program guides); in particular, an application called SURFER. As noted above, on the bottom of the screen there is a line of box art for linear channels, and when the user brings up that application, he or she can scroll back and forth across live channels. When he or she selects one of the pieces of box art, the system tunes to the corresponding channel. It is also possible to “arrow up” into a recent channels menu; the user can scroll through that menu and quickly tune back to what he or she was just looking at. One or more embodiments add VOD sessions and DVR sessions, such that if the user is watching a movie or recording and he or she stops or tunes away, he or she can bring up the app and his or her session will appear in the recent filtered list. The user can go to the last played list and select the desired asset and get back to the movie or recording. For example, the user could quickly tune to a football game to get the score and then go right back to a movie; there is no need to search through DVR assets and VOD assets to find the show he or she was watching.

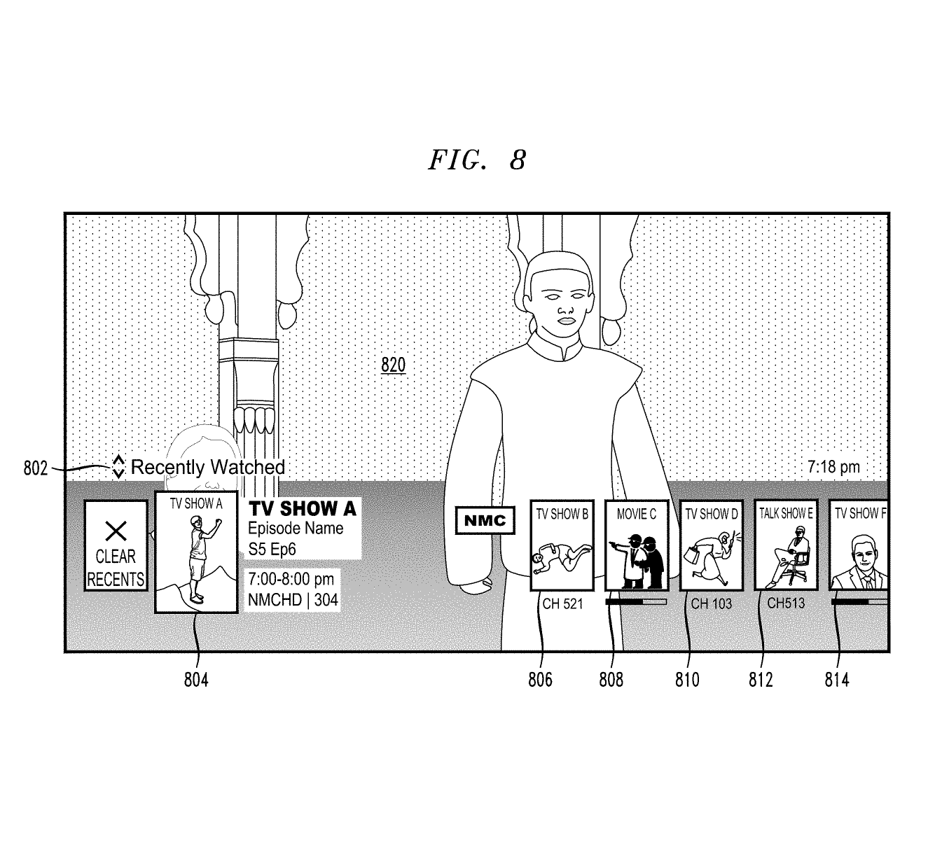

Referring to the exemplary screen shot of FIG. 8, note the list of recently watched shows 802. More precisely, element 802 shows a filter list with up and down carrots whereon “recently watched” has been selected; the box art icons of the recently watched shows are in a row at the bottom of the screen and discussed further below. Other items that could have been selected on the filter list 802 include “favorites,” “sports,” etc. The image 820 being displayed on the screen is what the user is currently watching; it can be live, VOD, or DVR. The box art icons 806, 810, 812 that show channel numbers work in the usual way (linear channels). The box art icons 808, 814 that show a progress bar are VOD or DVR sessions in accordance with aspects of invention. The user can scroll across and then can hit “OK” or “select” on a remote control or the like and the system will pick up playing the selected asset where the user left off. For example, if the user is initially watching a movie; the user types in a channel number for weather or the score of a game; then the user scrolls to whatever show he or she was watching and presses “play” and picks up where he or she left off. In the non-limiting example of FIG. 8, selections include TV Show B Channel 521 at 806, TV Show D Channel 103 at 810, Talk Show E Channel 513 at 812, the movie “MOVIE C” at 808 with a progress bar showing that the movie is about two thirds done, and a portion of box art for TV Show F at 814 with a progress bar. At 804 in the lower left-hand corner is displayed TV Show A 804—this is not what the user is currently watching; it is what the user would go back to; i.e., the most recent item in the recently watched list. In the non-limiting example of FIG. 8, TV Show A 804 is a linear asset being broadcast on channel 304. “Real” show and movie names other than A, B, C, etc. could of course be used in an actual implementation.

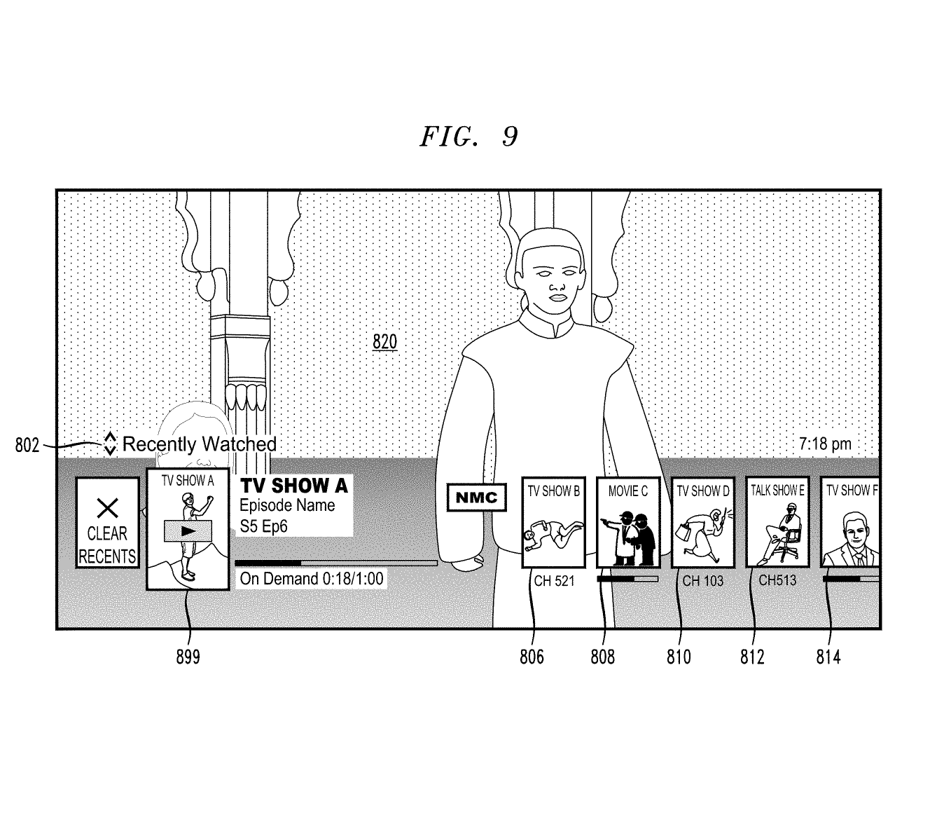

Referring to the exemplary screen shot of FIG. 9, the same is identical to that of FIG. 8 except that here, the most recent item in the recently viewed list, i.e., the TV Show A 899, is an on demand asset with a play icon and progress bar. Again, the TV Show A is not what the user is currently watching; the icon shows the asset he or she would go back to (the asset the user watched last). TV Show B 806 is the second most recent, MOVIE C 808 the third, and so on.

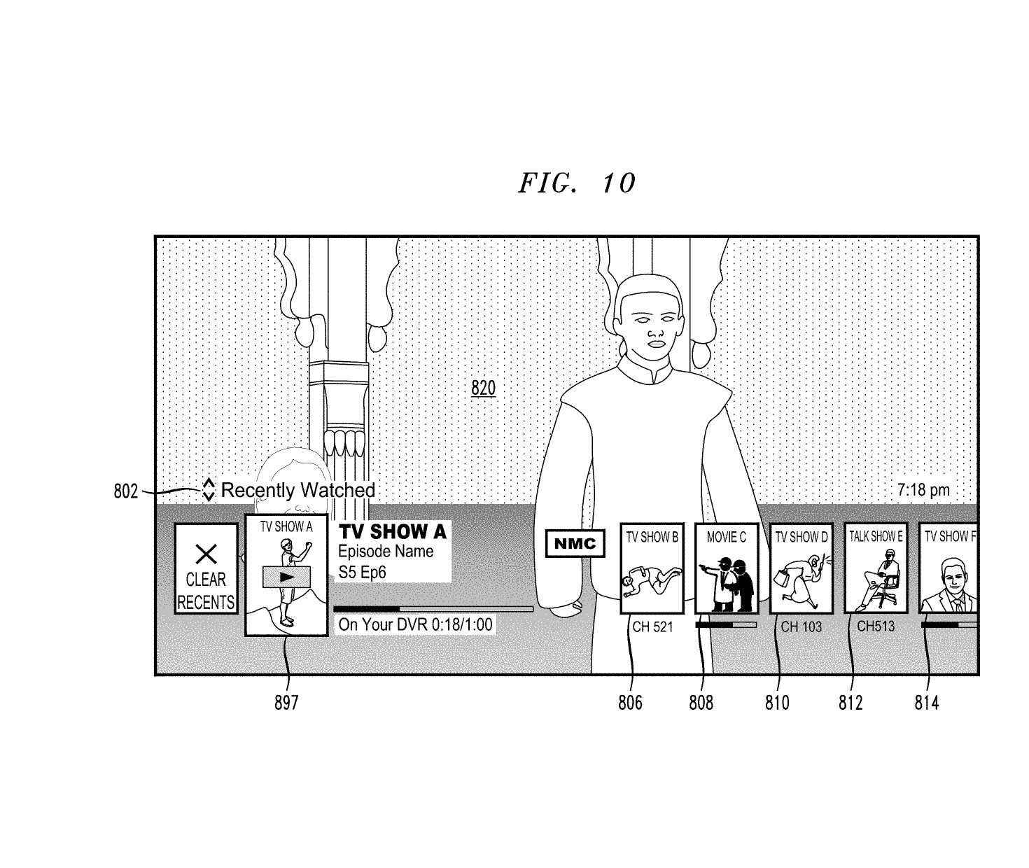

Referring to the exemplary screen shot of FIG. 10, the same is identical to that of FIGS. 8 and 9 except that here, the most recent item in the recently viewed list, i.e., the TV Show A 897, is a DVR asset. One or more embodiments deal with both cloud-based DVR assets and a local DVR in the premises (e.g., on the set-top box).

Heretofore, “recently watched” has been limited to linear (broadcast) content and has worked by maintaining a stack of channel numbers as strings. One or more embodiments employ new technology to permit the recently watched list to include non-linear (DVR or VOD) assets. In particular, one or more embodiments re-implement the assets as session objects, which can be linear, VOD, or DVR. The session is stacked onto the list. For example, if the stack is size fourteen, fourteen session objects can be stacked in any combination of VOD, linear, and DVR. They all follow the same general object-oriented programming (OOP) rules. They all share the same base class rules: how to remove duplicates (for linear, look for same channel number; for VOD look for VOD asset ID; for DVR, there is a unique recording ID). One or more embodiments look to the session object and see if it is a duplicate of the asset that is currently a candidate to be stacked; and if it is, the old asset is discarded and the new one is stacked.

One or more embodiments advantageously provide a quick way to leave a VOD or DVR session to check a football score, the weather, etc., then resume the VOD or DVR session exactly where the viewer left off. If the user left the VOD or DVR session to tune to a linear channel, currently, the only way to resume it is to go through a series of Menus and Box Art icons to find the same asset and resume it from where it left off.

One or more current “channel surfer” apps provide a “Recently Watched” filter similar to element 802 in FIG. 8. This filter allows the user to scroll through a predetermined number (e.g., fourteen) of his or her most recently watched linear (live) channels and to press <SELECT> to tune to that channel. FIG. 8 shows focused Box Art for the currently airing program on the last channel watched (Ch. 304), with the channel, call letters and airing time for the program displayed in the details area, as seen at 804. Pressing <SELECT> on the focused Box Art will tune to that channel at the live point.

One or more embodiments enhance the functionality of the prior art by providing the ability to stack VOD and/or DVR sessions on the channel surfer's “Recently Watched” stack. One or more embodiments re-architect an existing channel surfer to allow stacking video sessions for DVR and VOD onto the Surfer's Recently Watched Stack. Previously, the stack only included linear channel numbers, and so was just a stack of numeric strings corresponding to the channel numbers One or more embodiments modify the prior art to have a stack of session objects, where the object can be of type Linear, VOD, or DVR. Each type of session object adheres to a known interface for having itself stacked, removing duplicates, deletion rules, etc.

Advantageously, one or more embodiments allow the user to tune away from a VOD or DVR session, and then quickly resume his or her session from exactly where he or she left off without having to find the same asset through menus, applications, etc. One or more embodiments also allow for multiple sessions to be toggled at the same time; for example, a user can have both VOD and DVR assets active in the Recently Watched stack and can alternate between them if so desired.

A non-limiting example of using this feature is the following scenario: the user is watching a VOD movie and wants to know what the score of the football game is; he or she can simply tune to the linear channel of the football game, check the score, then press <UP> to bring up the channel surfer. The channel surfer is already focused on the VOD movie that was being watched, as seen at 899 in FIG. 9. By pressing <SELECT>, the user immediately resumes the VOD movie at the exact point from where he or she left off. The process for a DVR asset is similar, as seen in FIG. 10, except that 897 reads “On Your DVR” as opposed to “On Demand” at 899.

Note that the VOD and DVR sessions show a Progress Bar below the Box Art rather than the channel number when not focused, as seen at 808, 814. When focused, the Box Art image for a VOD or DVR asset also shows the large <PLAY> icon “>” which indicates that pressing <PLAY> will resume the session immediately from exactly where it left off, as seen at 897, 899.

In a non-limiting exemplary embodiment, the “recently viewed” items are stored on a stack (the term “stack” is well-known computer science terminology). In a non-limiting example, the Recently Viewed Stack includes a maximum of fourteen items (or other predetermined number). These items are defaulted to the fourteen linear channels closest to the tuned linear channel on initial boot. After the initial boot, the items are cached and/or persisted so that subsequent boots will retain the user's Recently Viewed Items. Using the Object-Oriented (OO) approach, each of these items is an instance of a RecentlyViewedItemBase class. The RecentlyViewedDvrItem, Recently ViewedLinearItem and RecentlyViewedVodItem classes extend the RecentlyViewedItemBase class to provide a class that implements the correct behavior for each respective asset type.

As the user watches other linear channels, VOD and/or DVR assets, the oldest item on the stack gets “popped,” and the asset currently being watched gets “pushed,” becoming the newest (or most recent) item on the stack. A “Factory” class can be implemented to provide the correct RecentlyViewedItem class instance for each asset type (e.g. Linear, DVR or VOD), based off of the current video session being stacked.

### RecentlyViewedStack

The RecentlyViewedStack is a stack specifically for stacking the user's Recently Viewed Items. In general, it is simply a common Stack in standard computer science terminology. In one or more embodiments:
1) On startup, the RecentlyViewedStack loads the persisted Recently Viewed Items from non-volatile random access memory (NVRAM) (if they have been persisted)
2) The Recently Viewed items are persisted to NVRAM at an appropriate time; in an exemplary embodiment, each time the stack is updated (since web applications (or crashes of STBs) will not proceed through a normal shutdown process, this approach is preferred to persisting on shutdown, which is another alternative)
3) When asked to “push” a new item, the client code calls with a Video Session object; this stack code creates a RecentlyViewedItem from that session and stacks it
4) When stacking a RecentlyViewedItem, the code first calls recently ViewedItem.removeDuplicate( ) to make sure a previous instance of this same asset does not appear twice on the stack

### RecentlyViewedItemBase Class

The RecentlyViewedItemBase class serves as the basis for all of the asset types: Linear, VOD and DVR. It enforces the API (Application Program Interface) that is needed to stack an item onto the RecentlyViewedStack and can be used to create new asset types (such as YOUTUBE video, for example) that also adhere to the API and are allowed to get stacked onto the “Recently Viewed” stack.

### Class Instance Variables for RecentlyViewedItemBase Class

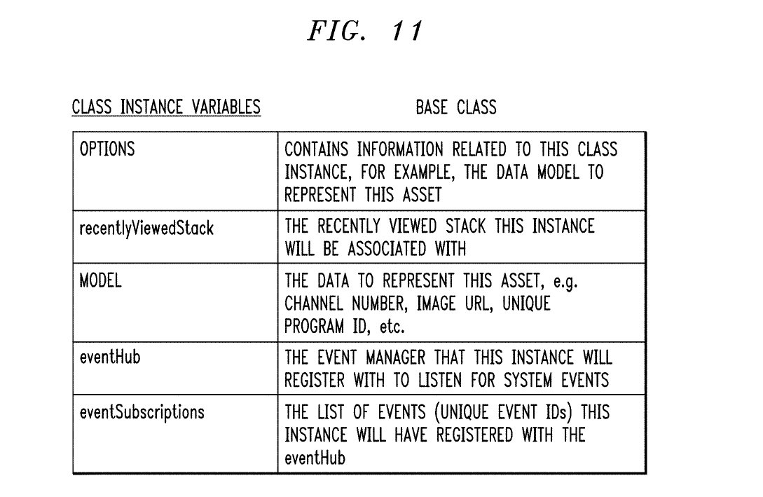

Pertinent class instance variables and their definitions are shown in FIG. 11.

### Methods for RecentlyViewedItemBase Class

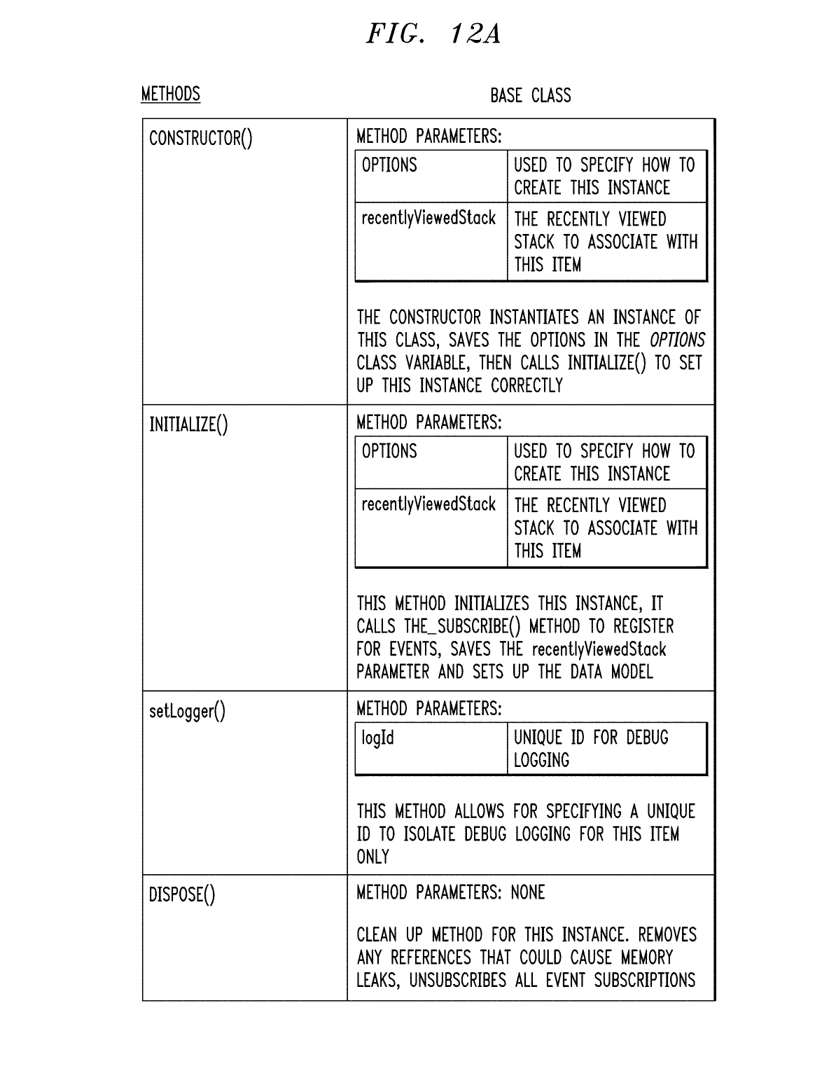

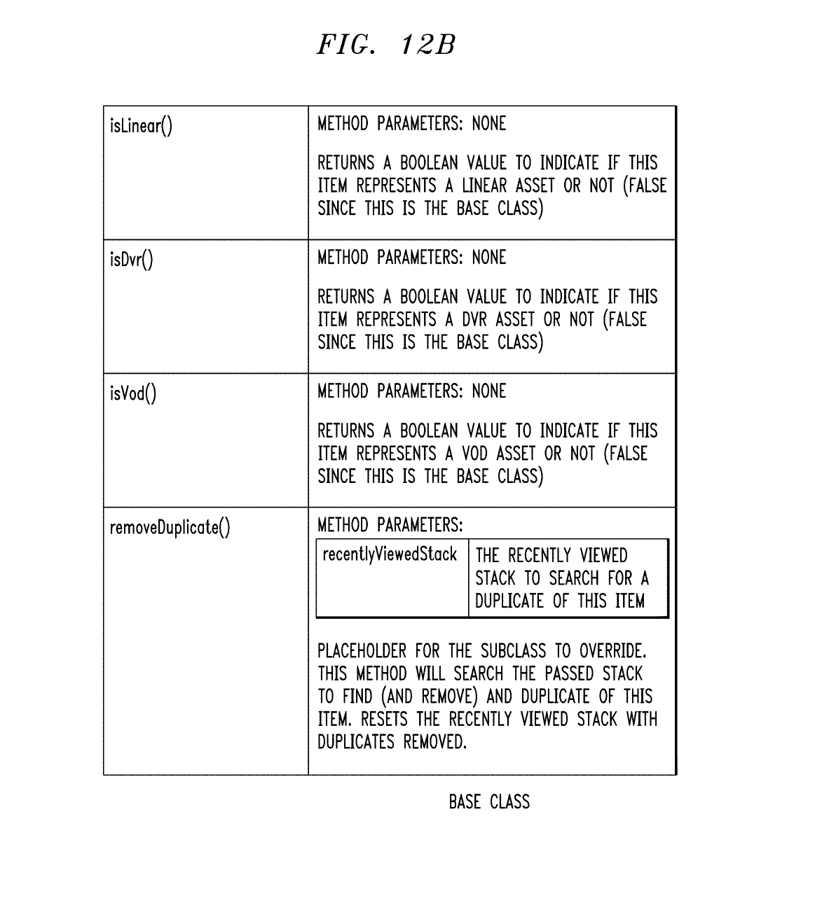

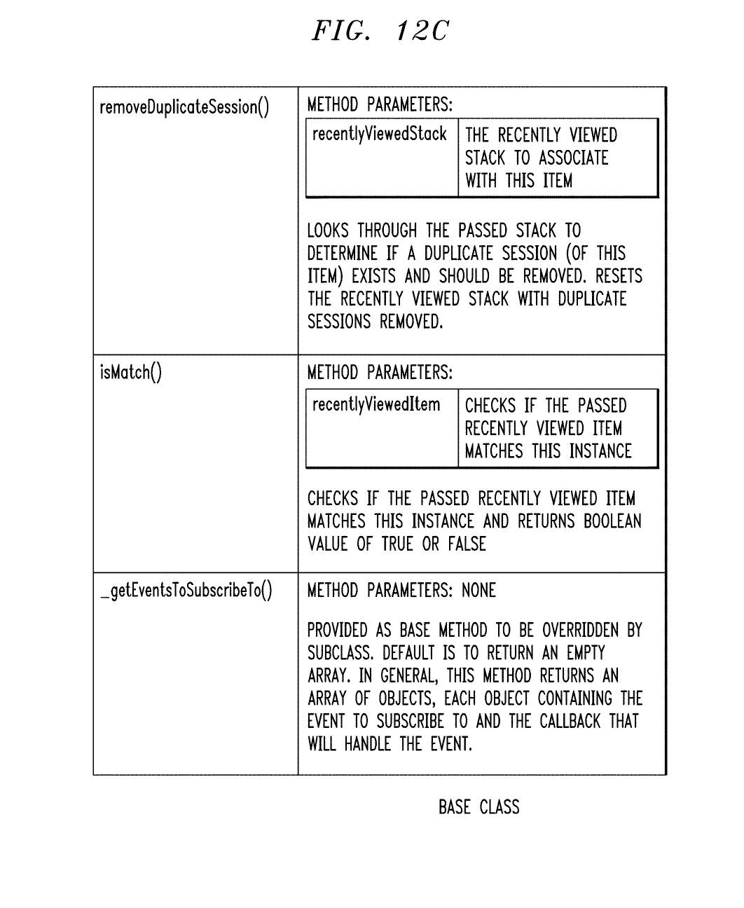

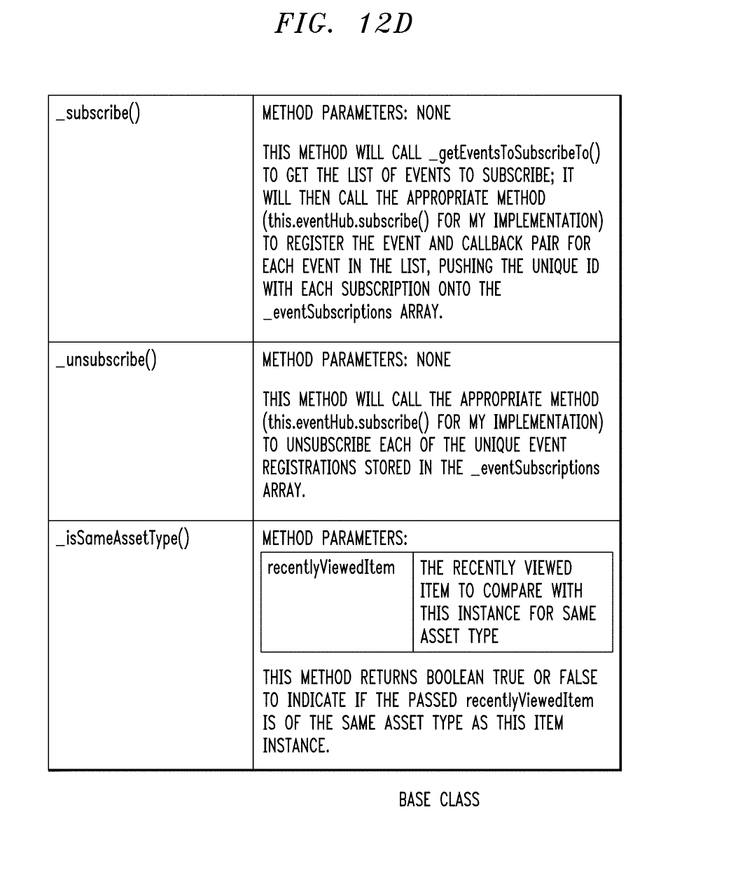

Pertinent methods and their parameters and definitions are shown in FIGS. 12A-12D.

### RecentlyViewedDvrItem Class

The RecentlyViewedDvrItem class represents the DVR asset type. It extends from the RecentlyViewedItemBase class and overrides several methods to get DVR-specific behavior.

### Class Instance Variables for RecentlyViewedDvrItem Class

These are the same as the base class in FIG. 11.

### Methods for RecentlyViewedDvrItem Class

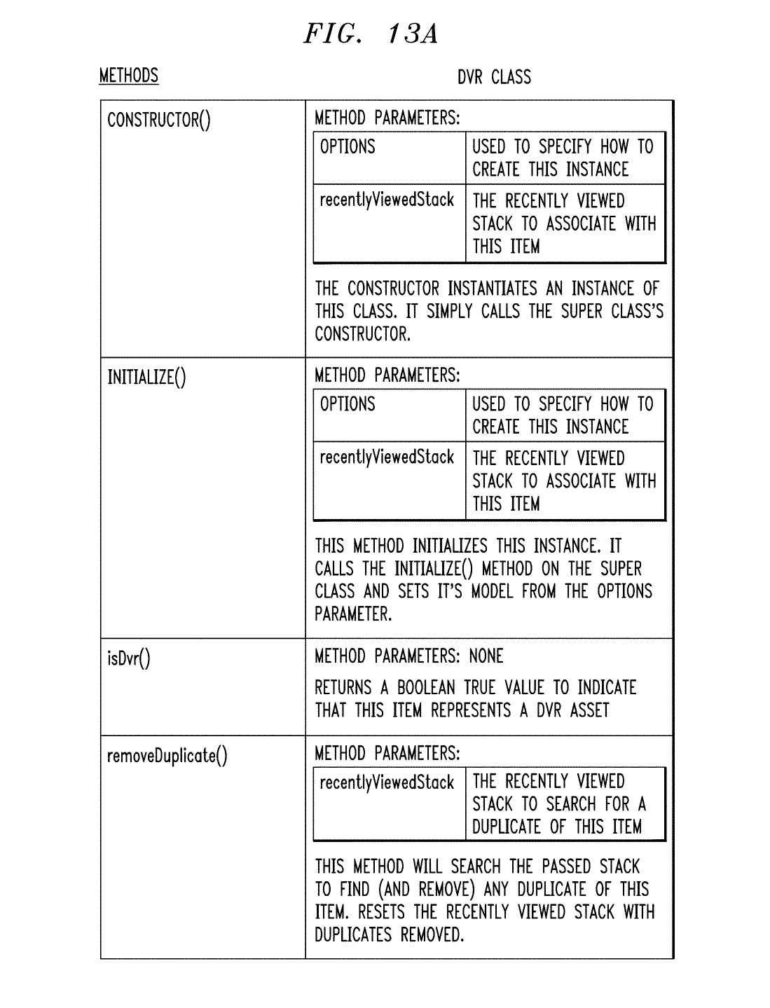

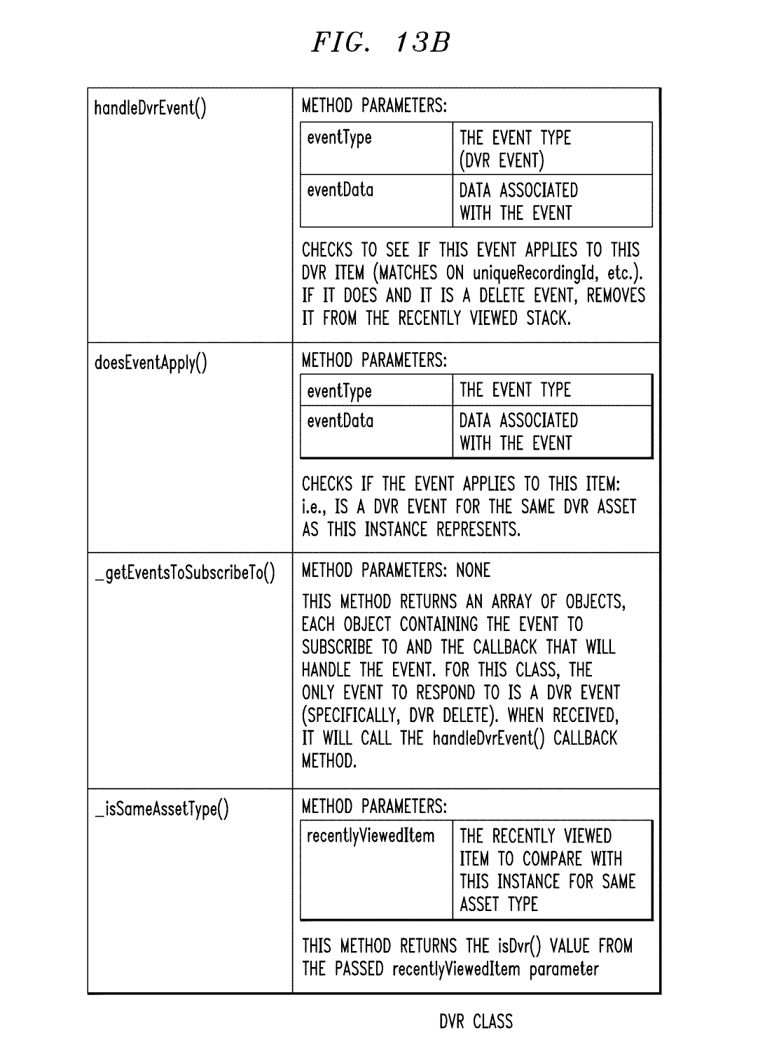

Pertinent methods and their parameters and definitions are shown in FIGS. 13A-13B.

### RecentlyViewedVodItem Class

The RecentlyViewedVodItem class represents the VOD asset type. It extends from the RecentlyViewedItemBase class and overrides several methods to get VOD-specific behavior.

### Class Instance Variables for RecentlyViewedVodItem Class

These are the same as the base class in FIG. 11.

### Methods for RecentlyViewedVodItem Class

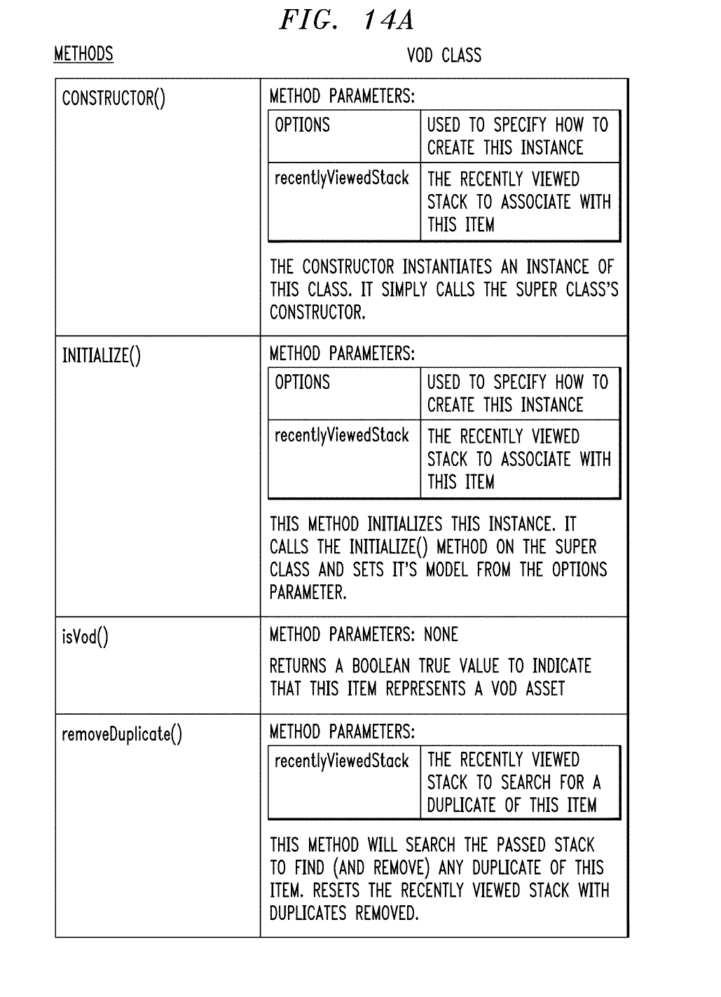

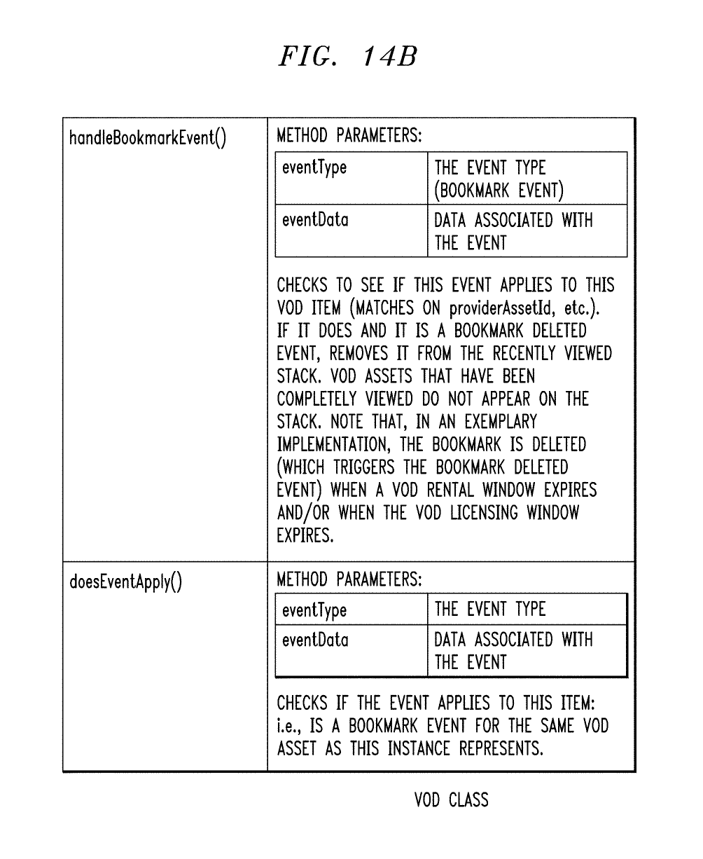

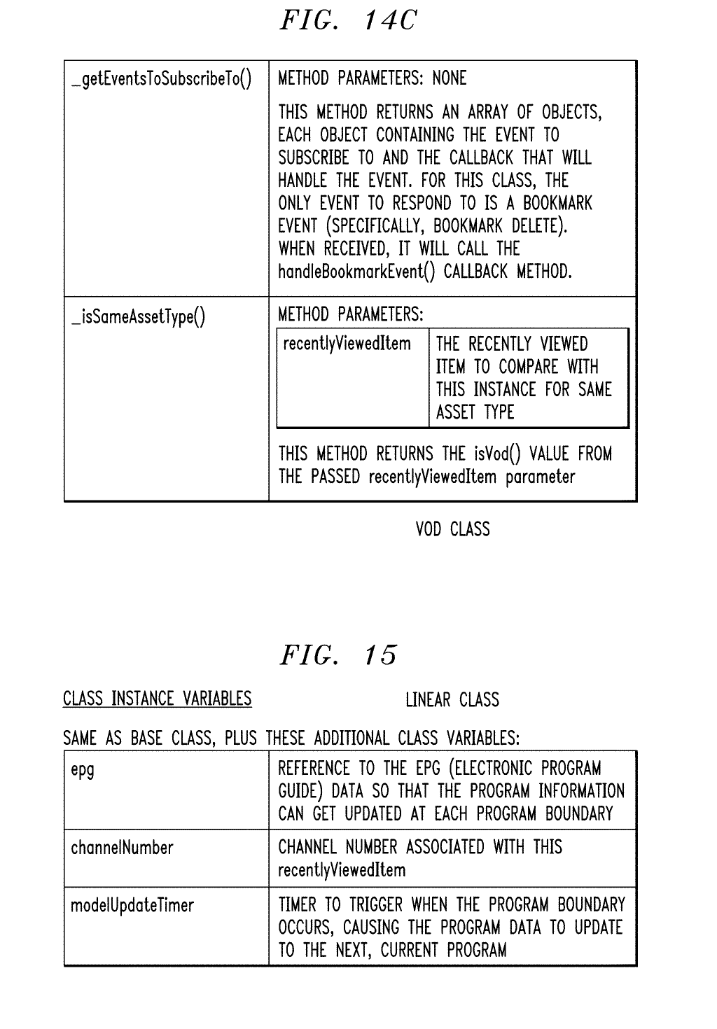

Pertinent methods and their parameters and definitions are shown in FIGS. 14A-14C.

### RecentlyViewedLinearItem Class

The RecentlyViewedLinearItem class represents the linear (live TV) asset type. It extends from the RecentlyViewedItemBase class and overrides several methods to get Linear-specific behavior.

Another pertinent aspect of the linear item is that it represents a specific channel. The BoxArt image and associated program data (Title, Episode Information, Description, etc.) can change over time as the programs change on that channel. Therefore, in one or more embodiments, this item handles updating its data model on program boundaries so that it always reflects the currently airing program on the associated channel.

### Class Instance Variables for RecentlyViewedLinearItem Class

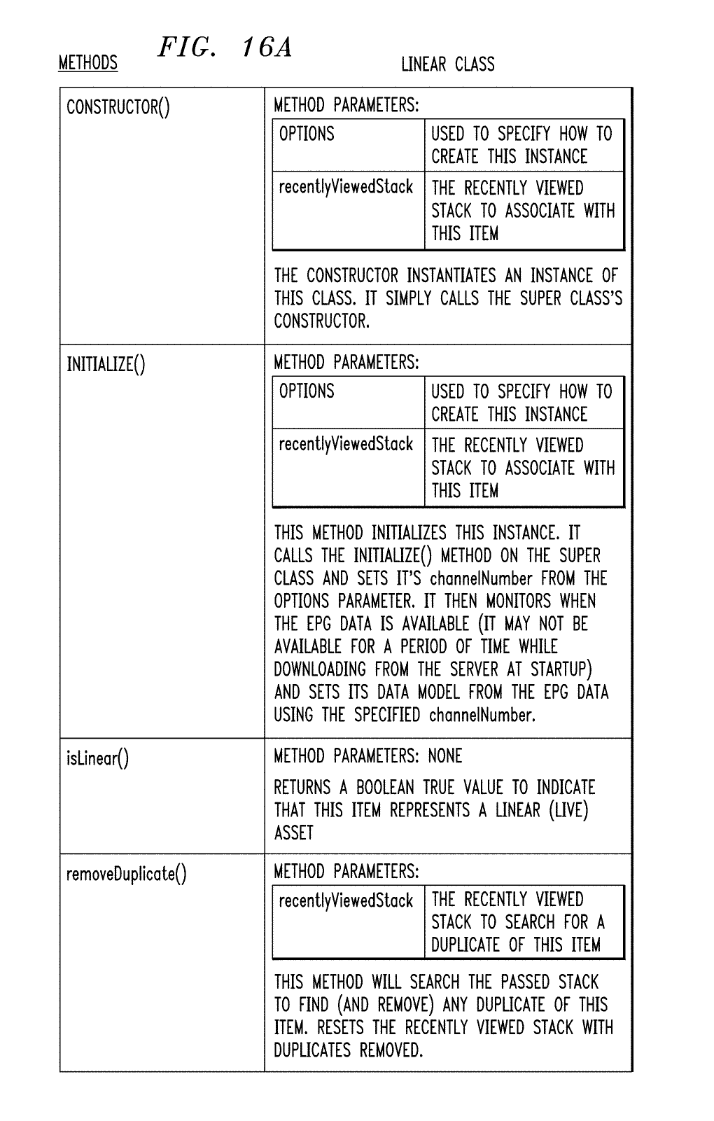

These include those in the base class in FIG. 11, as well as the additional class variables shown in FIG. 15.

### Methods for RecentlyViewedLinearItem Class

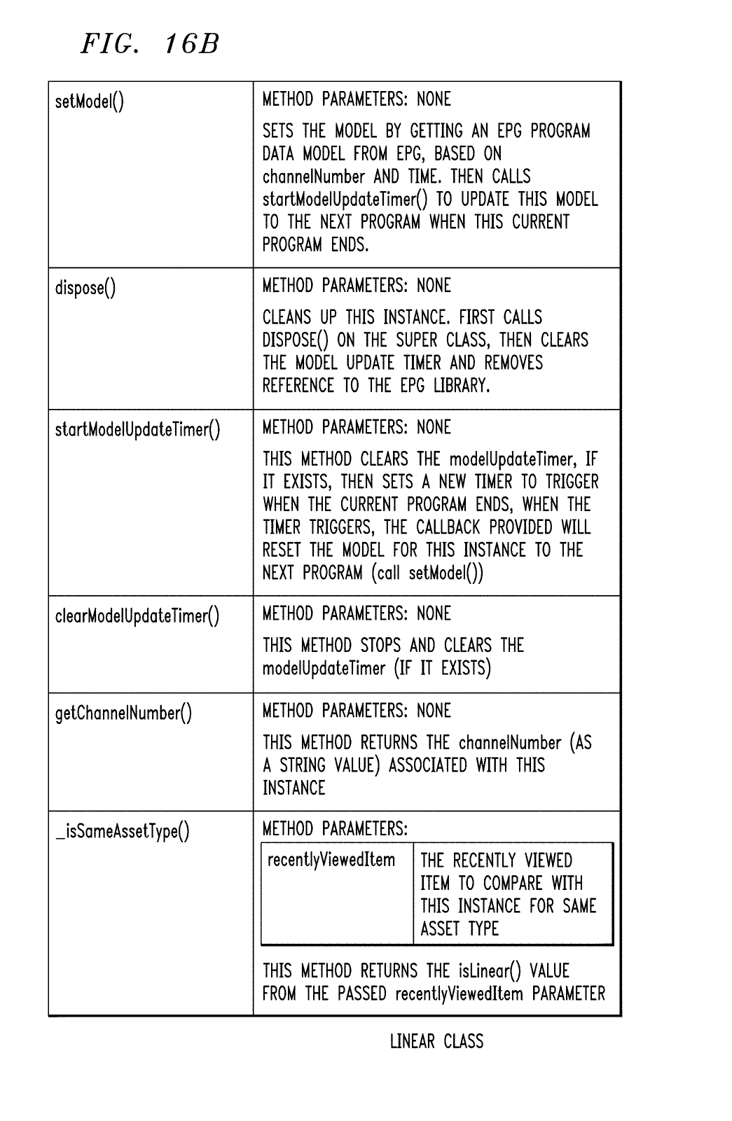

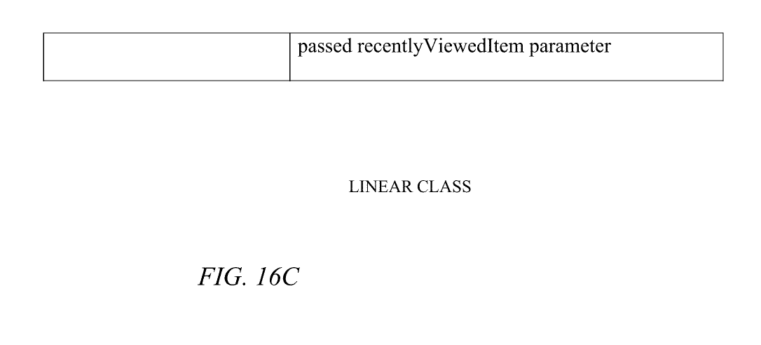

Pertinent methods and their parameters and definitions are shown in FIGS. 16A-16C.

The application(s) and associated data structure(s) (e.g., stack) implementing the disclosed techniques can reside in a single location or can be distributed over multiple locations. In some cases, a client-server architecture can be employed with the CPE as the client. The CPE and attached television provide a user interface accessible by a remote control or the like. Other approaches can be used in other embodiments. Non-limiting examples of locations at which elements can reside include:

in an NDC 1098;

in an RDC 1048;

in a head end 150;

on CPE 106.

In a presently preferred but non-limiting embodiment, the pertinent code resides on the client (e.g., a set-top terminal) with material persisted locally in a non-volatile random-access memory (NVRAM) without the need to persist to a server; in other embodiments, material is persisted to a server or other cloud location.

Given the discussion thus far, it will be appreciated that, in general terms, an exemplary method, according to an aspect of the invention, includes the step of forming a recently-viewed stack of session objects corresponding to assets recently played on consumer premises equipment 106 in a video content network. The session objects include linear (e.g. broadcast) session objects corresponding to linear ones of the assets and non-linear (e.g., VOD or DVR) session objects corresponding to non-linear ones of the assets. A further step includes obtaining a user selection (e.g. from a remote control) to resume playing one of the non-linear ones of the assets. An even further step includes, responsive to the user selection, switching from a currently viewed program to the one of the non-linear ones of the assets. As discussed above, in an exemplary embodiment, each type of session object adheres to a known interface for having itself stacked, removing duplicates, deletion rules, etc.

In a preferred but non-limiting approach, the obtaining step includes obtaining the user selection from a channel surfer application (e.g., through the “Surfer” user interface). Linear, VOD and DVR can be resumed by other techniques (such as navigating to and through menus and the like); one or more presently preferred embodiments provide a quick technique to “resume” through the Surfer user interface or similar channel surfer application.

In at least some instances, the non-linear session objects include video-on-demand session objects corresponding to video-on-demand assets and digital video recorder objects corresponding to digital video recorder assets. In some such cases, in the obtaining step, the user selection includes a user selection to resume playing one of the video-on-demand assets, and the switching step includes switching from the currently viewed program to the one of the video-on-demand ones of the assets. In other such cases, in the obtaining step, the user selection includes a user selection to resume playing one of the digital video recorder assets; and the switching step includes switching from the currently viewed program to the one of the digital video recorder ones of the assets.

In the switching step, the currently viewed program can be a linear program or a non-linear program. As discussed above, one or more embodiments also allow for multiple sessions to be toggled at the same time; for example, a user can have both VOD and DVR assets active in the Recently Watched stack and can alternate between them if so desired.

A further step in at least some embodiments includes persisting the recently-viewed stack of session objects to non-volatile memory at an appropriate time (e.g., each time the stack is updated). In such instances, an even further step includes retrieving the recently-viewed stack of session objects from the non-volatile memory upon subsequent system re-start. As discussed above, after the initial boot, the items are cached and/or persisted so that subsequent boots will retain the user's Recently Viewed Items.

In one or more embodiments, upon the user switching to a new program, a request is obtained to push a session object corresponding to the new program to the recently-viewed stack of session objects. The session object corresponding to the new program is added to the recently-viewed stack of session objects, responsive to obtaining the request. As discussed above, when asked to “push” a new item, the client code calls with a Video Session object; the stack code creates a RecentlyViewedItem from that session and stacks it.

In at least some cases, the recently-viewed stack of session objects has a maximum number of entries, and a further step includes deleting the oldest one of the entries, responsive to obtaining the request. As discussed above, in a non-limiting example, the Recently Viewed Stack includes a maximum of fourteen items (or other predetermined number). These items are defaulted to the fourteen linear channels closest to the tuned linear channel on initial boot. As the user watches other linear channels, VOD and/or DVR assets, the oldest item on the stack gets “popped,” and the asset currently being watched gets “pushed,” becoming the newest (or most recent) item on the stack. A “Factory” class can be implemented to provide the correct RecentlyViewedItem class instance for each asset type (e.g. Linear, DVR or VOD), based off of the current video session being stacked.

In one or more embodiments, further steps include, responsive to obtaining the request, checking whether a duplicate of the session object corresponding to the new program already exists in the recently-viewed stack of session objects, and, if the duplicate of the session object corresponding to the new program already exists in the recently-viewed stack of session objects, deleting the duplicate of the session object corresponding to the new program. As discussed above, when stacking a RecentlyViewedItem, the code first calls recently ViewedItem.removeDuplicate( ) to make sure a previous instance of this same asset does not appear twice on the stack.

As noted, the non-linear session objects can include, for example, video-on-demand session objects corresponding to video-on-demand ones of the assets and digital video recorder objects corresponding to digital video recorder ones of the assets. In at least some such instances, each of the session objects is assigned to a RecentlyViewedItemBase class, each of the linear session objects is assigned to a RecentlyViewedLinearItem class, each of the video-on-demand session objects is assigned to a RecentlyViewedVodItem class, and each of the digital video recorder session objects is assigned to a RecentlyViewedDvrItem class. The items are handled in accordance with their class membership; for example, the manner of checking for duplicates is based on membership in one of the RecentlyViewedLinearItem class, the RecentlyViewedVodItem class, and the RecentlyViewedDvrItem class. DVR items are identified by a unique recording ID, VOD items by asset ID, linear items by channel number and/or EPG data, and so on.

In another aspect, an exemplary apparatus (in a non-limiting example, a set-top terminal interfacing with a video content network or the like) includes a memory such as 310 or 730; at least one processor such as 306 or 720 coupled to the memory; and a non-transitory persistent storage medium (e.g. 308) which contains instructions which, when loaded into the memory, configure the at least one processor to be operative to carry out any one, some, or all of the method steps herein.

In still another aspect, an exemplary non-transitory computer readable medium includes computer executable instructions which when executed by a computer cause the computer to perform any one, some, or all of the method steps herein.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus (e.g., server, CPE, remote control) including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors (e.g., system 700 discussed below), or (iii) a combination of (i) and (ii); any of (i)-(iii) implement the specific techniques set forth herein, and the software modules are stored in a tangible computer-readable recordable storage medium (or multiple such media). The means do not include transmission media per se or disembodied signals per se. Appropriate interconnections via bus, network, and the like can also be included.

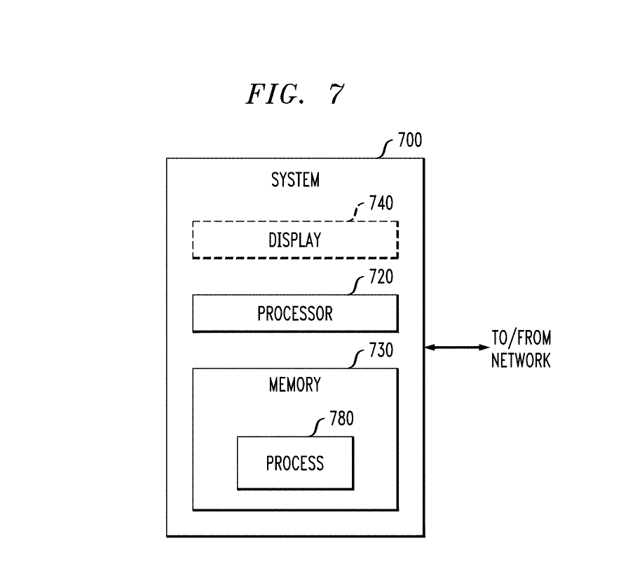

FIG. 7 is a block diagram of a system 700 that can implement at least some aspects of the invention, and is representative, for example, of one or more of the servers or personal computers shown in the figures. As shown in FIG. 7, memory 730 configures the processor 720 to implement one or more methods, steps, and functions (collectively, shown as process 780 in FIG. 7). The memory 730 could be distributed or local and the processor 720 could be distributed or singular. Different steps could be carried out by different processors.

The memory 730 could be implemented as an electrical, magnetic or optical memory, or any combination of these or other types of storage devices. It should be noted that if distributed processors are employed, each distributed processor that makes up processor 720 generally contains its own addressable memory space. It should also be noted that some or all of computer system 700 can be incorporated into an application-specific or general-use integrated circuit. For example, one or more method steps could be implemented in hardware in an ASIC (application specific integrated circuit) or FPGA (field programmable gate array) rather than using firmware. Display 740 is representative of a variety of possible input/output devices (e.g., keyboards, mice, and the like). Every processor may not have a display, keyboard, mouse or the like associated with it.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system (including, for example, system 700 or the like), to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass a transmission medium or disembodied signal.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, for example, on a set-top box, a personal computer; a virtualized or non-virtualized hardware server, and the like, and that such program may be embodied on a tangible computer readable recordable storage medium. As used herein, including the claims, unless it is unambiguously apparent from the context that only server software is being referred to, a “server” includes a physical data processing system (for example, system 700 as shown in FIG. 7) running one or more server programs. It will be understood that such a physical server may or may not include a display, keyboard, or other input/output components.

Furthermore, it should be noted that any of the methods described herein can include an additional step of providing a system comprising distinct software modules embodied on one or more tangible computer readable storage media. All the modules (or any subset thereof) can be on the same medium, or each can be on a different medium, for example. The modules can include any or all of the components disclosed herein. The method steps can then be carried out using the distinct software modules of the system, as described herein, executing on one or more hardware processors (e.g., one or more hardware processors of a set-top box, a personal computer; a virtualized or non-virtualized hardware server, and the like) and utilizing intermediate network links and network nodes. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method comprising the steps of:
forming a recently-viewed stack of session objects corresponding to assets recently played on consumer premises equipment in a video content network, wherein said session objects comprise linear session objects corresponding to linear ones of said assets and non-linear session objects corresponding to non-linear ones of said assets;
obtaining a user selection to resume playing one of said non-linear ones of said assets; and
responsive to said user selection, switching from a currently viewed program to said one of said non-linear ones of said assets.

2. The method of claim 1, wherein said obtaining step comprises obtaining said user selection from a channel surfer application.

3. The method of claim 2, wherein:
said non-linear session objects comprise video-on-demand session objects corresponding to video-on-demand ones of said assets and digital video recorder objects corresponding to digital video recorder ones of said assets;
in said obtaining step, said user selection comprises a user selection to resume playing one of said video-on-demand ones of said assets; and
said switching step comprises switching from said currently viewed program to said one of said video-on-demand ones of said assets.

4. The method of claim 2, wherein:
said non-linear session objects comprise video-on-demand session objects corresponding to video-on-demand ones of said assets and digital video recorder objects corresponding to digital video recorder ones of said assets;
in said obtaining step, said user selection comprises a user selection to resume playing one of said digital video recorder ones of said assets; and
said switching step comprises switching from said currently viewed program to said one of said digital video recorder ones of said assets.

5. The method of claim 2, wherein, in said switching step, said currently viewed program comprises a linear program.

6. The method of claim 2, wherein, in said switching step, said currently viewed program comprises a non-linear program.

7. The method of claim 2, further comprising persisting said recently-viewed stack of session objects to non-volatile memory at an appropriate time.

8. The method of claim 7, wherein said appropriate time comprises update of said stack.

9. The method of claim 8, further comprising retrieving said recently-viewed stack of session objects from said non-volatile memory upon subsequent system re-start.

10. The method of claim 8, further comprising:
upon said user switching to a new program, obtaining a request to push a session object corresponding to said new program to said recently-viewed stack of session objects; and
adding said session object corresponding to said new program to said recently-viewed stack of session objects, responsive to obtaining said request.

11. The method of claim 10, wherein said recently-viewed stack of session objects has a maximum number of entries, further comprising deleting an oldest one of said entries, responsive to obtaining said request.

12. The method of claim 10, further comprising:
responsive to obtaining said request, checking whether a duplicate of said session object corresponding to said new program already exists in said recently-viewed stack of session objects; and
if said duplicate of said session object corresponding to said new program already exists in said recently-viewed stack of session objects, deleting said duplicate of said session object corresponding to said new program.

13. The method of claim 12, wherein said non-linear session objects comprise video-on-demand session objects corresponding to video-on-demand ones of said assets and digital video recorder objects corresponding to digital video recorder ones of said assets, further comprising:
assigning each of said session objects to a RecentlyViewedItemBase class;
assigning each of said linear session objects to a RecentlyViewedLinearItem class;
assigning each of said video-on-demand session objects to a RecentlyViewedVodItem class; and
assigning each of said digital video recorder session objects to a RecentlyViewedDvrItem class;
wherein a manner of said checking for said duplicate is based on membership in one of said RecentlyViewedLinearItem class, said RecentlyViewedVodItem class, and said RecentlyViewedDvrItem class.

14. An apparatus comprising:
a memory;
at least one processor coupled to said memory; and
a non-transitory persistent storage medium which contains instructions which, when loaded into said memory, configure said at least one processor to be operative to:
form a recently-viewed stack of session objects corresponding to assets recently played on consumer premises equipment in a video content network, wherein said session objects comprise linear session objects corresponding to linear ones of said assets and non-linear session objects corresponding to non-linear ones of said assets;
obtain a user selection to resume playing one of said non-linear ones of said assets; and
responsive to said user selection, switch from a currently viewed program to said one of said non-linear ones of said assets.

15. The apparatus of claim 14, wherein said user selection is obtained from a channel surfer application.

16. The apparatus of claim 15, wherein:
said non-linear session objects comprise video-on-demand session objects corresponding to video-on-demand ones of said assets and digital video recorder objects corresponding to digital video recorder ones of said assets;
said user selection comprises a user selection to resume playing one of said video-on-demand ones of said assets; and
said switching comprises switching from said currently viewed program to said one of said video-on-demand ones of said assets.

17. The apparatus of claim 15, wherein:
said non-linear session objects comprise video-on-demand session objects corresponding to video-on-demand ones of said assets and digital video recorder objects corresponding to digital video recorder ones of said assets;
said user selection comprises a user selection to resume playing one of said digital video recorder ones of said assets; and
said switching comprises switching from said currently viewed program to said one of said digital video recorder ones of said assets.

18. A non-transitory computer readable medium comprising computer executable instructions which when executed by a computer cause the computer to perform the method of:
forming a recently-viewed stack of session objects corresponding to assets recently played on consumer premises equipment in a video content network, wherein said session objects comprise linear session objects corresponding to linear ones of said assets and non-linear session objects corresponding to non-linear ones of said assets;
obtaining a user selection to resume playing one of said non-linear ones of said assets; and
responsive to said user selection, switching from a currently viewed program to said one of said non-linear ones of said assets.

19. The non-transitory computer readable medium of claim 18, wherein said obtaining step of said method comprises obtaining said user selection from a channel surfer application.

20. The non-transitory computer readable medium of claim 19, wherein:
said non-linear session objects comprise video-on-demand session objects corresponding to video-on-demand ones of said assets and digital video recorder objects corresponding to digital video recorder ones of said assets;
in said obtaining step of said method, said user selection comprises a user selection to resume playing one of said video-on-demand ones of said assets; and
said switching step of said method comprises switching from said currently viewed program to said one of said video-on-demand ones of said assets.

21. The non-transitory computer readable medium of claim 19, wherein:
said non-linear session objects comprise video-on-demand session objects corresponding to video-on-demand ones of said assets and digital video recorder objects corresponding to digital video recorder ones of said assets;
in said obtaining step of said method, said user selection comprises a user selection to resume playing one of said digital video recorder ones of said assets; and
said switching step of said method comprises switching from said currently viewed program to said one of said digital video recorder ones of said assets.
